(19) United States
(12) Patent Application Publication
(10) Pub. No.: US 2003/0167159 A1
(43) Pub. Date: Sep. 4, 2003

(54) Method for determining molecular surface areas and volumes

(75) Inventors: William A. Goddard III, Pasadena, CA (US); Joseph Danzer, Pasadena, CA (US); Georgios Zamakos, New York, NY (US)

Correspondence Address: PERKINS COIE LLP, POST OFFICE BOX 1208, SEATTLE, WA, 98111-1208, US

(73) Assignee: California Institute of Technology

(21) Appl. No.: 10/265,061

(22) Filed: Oct. 4, 2002

Related U.S. Application Data
(60) Provisional application No. 60/327,154, filed on Oct. 4, 2001.

(51) Int. Cl. G06G 7/48; G06G 7/58

(52) U.S. Cl. 703/12

(57) ABSTRACT

The present invention relates to methods for determining the molecular volume and surface area of a solvated solute. One aspect of the present invention is a method for determining the born radii using the methods according to the invention for determining the molecular volume of a solvated solute. Because the methods according to the invention are based upon analytical formulas, the claimed methods are computationally efficient, robust and parallelizable.

This application claims priority to U.S. patent application Ser. No. 60/327,154 filed Oct. 4, 2001, and now pending. Ser. No. 60/327,154 is incorporated herein by reference.

### FIELD OF THE INVENTION

The invention relates to the field of computational methods for determining molecular surface area and volume.

### BACKGROUND

In-silico molecular simulations are increasingly playing an important role in guiding drug development and understanding biological systems by permitting the simulation of biochemical interactions such as binding events or conformation. Molecular simulations permit the understanding of how a small molecule binds a protein receptor or how the aqueous environment inside cells affects protein folding.

Solvation effects are of primary importance on the structure and function of biological macromolecules. Water, in particular, is the environment in which all biological functions take place and has a profound impact on biochemistry. Biological macromolecules such as proteins take shape and perform their functions in water. Accordingly, there is a need for methods which efficiently and accurately model solvent properties and the properties of solute/solvent systems. Among the most basic properties to be calculated are the volume of a solvated solute molecule, its solvent accessible surface area (SASA) and the free energy of solvation ΔGₛₒₗ. ΔGₛₒₗ may be conceptually understood as the amount of free energy required to fully solvate a solute. Mathematically ΔGₛₒₗ may be decomposed into three terms:

ΔGₛₒₗᵥ=ΔGₚₒₗ+ΔG_{cav}+ΔG_{vdW} (1)

Gₚₒₗ is the polarization energy of solvation, G_{cav} is the energy required to create a cavity in the solvent in which the molecule can fit and G_{vdW} is the energy due to short-range dispersion effects between solvent and solute (van der Waals forces). The cavity and van der Waals terms are due to short-range effects so we assume that they are dependent only on the exposed surface area of the molecule:

$${G}_{cav} + {G}_{vdW} = {\sum }_{i = 1}^{N} {σ}_{i} {A}_{i} \qquad ( 2 )$$

The parameter σᵢ represents the surface tension for atom i and Aᵢ is the solvent accessible surface area for atom i, assuming a fused-sphere model for the molecule. This area-dependent part of the energy is called the cavity term. The surface tensions σᵢ are empirically determined parameters and depend on the atom, its local environment in the molecule and the solvent environment. For this calculation and the determination of forces (\vec{F}ᵢ=−∇ᵢGₛₒₗᵥ) it is necessary to have a fast and efficient calculation of the SASA and its gradients with respect to atomic coordinates.

For the calculation of the electrostatic contribution to the salvation energy we make the assumption that the solvent behaves like a dielectric continuum and the electrostatic energy is related to the polarization of the solute due to the solvent and vice-versa. Such a model can be solved analytically and accurately by means of the Poisson-Boltzman (PB) equation:

∇(ε(\vec{r})·∇(Φ(\vec{r})))+A sin h(Bε(\vec{r})Φ(\vec{r})=4πρ(\vec{r}) (3)

In equation (6), Φ(\vec{r}) is the electrostatic potential, ε(\vec{r}) is the dielectric constant of the continuum, ρ(\vec{r}) the charge density of the solute and A and B are terms that depend on the salt concentration and temperature of the system. This is a non-linear, three-dimensional, partial differential equation that can only be solved numerically for systems of arbitrary shape. Also, its solution is computationally costly as it scales O(N³), where N is the number of atoms in the molecule.

A number of numerical methods have been developed for the numerical solution of the PB equation either using finite differences or boundary element methods. The best known in the literature are the DelPhi program, Gilson M. K. Honig, B., Proteins, 4, 7 (1988), UHBD, Davis M. E., McCammon J. A., J. Comput. Chem., 10, 386 (1989), and PBF, Cortis, C. M., Frisner R. A., J. Comput. Chem., 18, 1591 (1989). A significant deficiency with numerical methods is that they do not calculate the solvation electrostatic forces along with the energies. These forces can be computed but only at a great computational expense since they would have to be calculated from numerical differences. This makes numerical methods useless for molecular mechanics simulations. At the same time, since a spatial grid is used in order to solve the PB equation, the accuracy of the solution and the CPU time needed for its calculation are highly dependent on the density of the grid. Too sparse a grid would result in fast calculations with inaccurate solutions. Too fine a grid would result in accurate solutions but slow calculations. For example, DelPhi would take about 25 minutes on a 195 MHz SGI processor to solve problems on a 185×185×185 grid for a system of 600 atoms. Also, since the solution is based on a grid, the algorithm used will scale with the size of the solute as O(N³), where N is the number of molecules, making it impractical for studying very large systems. Finally, parallelization of such algorithms has met with limited success.

Accordingly, one object of the present invention is to present a method for calculating a solution to the PB equation that correlates well to numerical solutions of the PB equation qualitatively and quantitatively, with analytical formulas so that the calculation is computationally tractable.

We start with the Generalized Born (GB) model to the PB equation. In this model, the polarization energy of salvation is given by:

$${G}_{pol} = - \frac{1}{2} ( \frac{1}{{ϵ}_{in}} - \frac{1}{{ϵ}_{out}} ) {\sum }_{i , j = 1}^{N} \frac{{q}_{i} {q}_{j}}{{f}_{ij}} \qquad ( 4 )$$

In equation (4), qᵢ is the charge of atom i, εᵢₙ and εₒᵤₜ are the dielectric constants inside and outside of the solute respectively. fᵢⱼ is given by:

$${f}_{ij} = \sqrt{{r}_{ij}^{2} + {α}_{i} {α}_{j} exp ( - \frac{{r}_{ij}^{2}}{4 {α}_{i} {α}_{j}} )} \qquad ( 5 )$$

In equation (5) rᵢⱼ is the interatomic distance between atoms i and j. The parameter αᵢ, the Born Radius, describes the self-energy of atom i in the cavity of the solute surrounded by the solvent. The Born radius, assuming the coulombic approximation, may be represented by the formula:

$$\frac{1}{{α}_{k}} = \frac{1}{R} - \frac{1}{4 π} {\int }_{{Ω}_{k}}^{} \frac{1}{{\vert {r}^{->} - {{r}^{->}}_{k} \vert}^{4}} {ⅆ}^{3} r \qquad ( 6 )$$

The integration volume Ωᵢ, as is formally described in (6), is over the whole solute volume Vₛₒₗᵤₜₑ, excluding a sphere from the center of atom i, \vec{r}ᵢ, with radius Rᵢ, the van der Waals radius of atom i. The integral over the volume Ωᵢ in Equation (6) cannot be calculated analytically for all but the simplest case of a spherical solute. For that reason there has been considerable interest in the literature for the calculation of this integral.

Perhaps the most straightforward way to calculate such integral for arbitrary geometries is by numerical integration. The integration domain is divided by a cubic grid, elements of which are assigned as being inside or outside the solute. Then each grid element (of volume ΔV and center coordinate \vec{r}) contributes ΔV/|\vec{r}-\vec{r}ₖ| to the integral of the Born radius for atom k. Comparisons of the results of this method with numerical solutions of the PB equation on a set of small molecules and molecular complexes show that the GB results correlate very well to the PB answers, although there is a systematic error, Scarci M., Apostolakis J., Caflisch A., J Phys. Chem. A., 101, 8098 (1997). However, the numerical integration is not practical for molecular simulations since it lacks derivatives (which are necessary for the calculation of forces), it is very slow and the accuracy and speed depend on the resolution of the grid used.

Since the numerical solution is not practical and we need an analytical formula to calculate gradients, the asymptotic model attempts to provide an ad-hoc analytical solution. This model assumes that the Born radius of atom i is given by:

$$\begin{matrix}\frac{1}{{α}_{i}} = \frac{1}{{R}_{i} + φ + {P}_{1}} - \{ {\sum }_{j ∈ stretch} \frac{{P}_{2} {V}_{j}}{{r}_{ij}^{4}} + \\ {\sum }_{j ∈ bend} \frac{{P}_{3} {V}_{j}}{{r}_{ij}^{4}} + {\sum }_{j ∈ nonbond} \frac{{P}_{4} {V}_{j} C}{{r}_{ij}^{4}} \}\end{matrix} \qquad ( 7 )$$

Qiu D., Shenkin P. S., Hollinger F. P., Still W. C., J. Phys. Chem. A, 101, 3005 (1997). The parameters φ, P₁, P₂, P₃, P4, are scaling factors that are determined by fitting the predicted solvation energies to the numerical solutions of the PB equation for a set of small molecules. C is a “close contact function” that adjusts radii for nonbonded atoms that are too close to the central atom i, and Vⱼ is the van der Waals volume of atom j.

The similarity of equation (7) to equation (6) is clear. Equation (7) is an ad-hoc formula with little formal justification besides the fact that the term Vⱼ/rᵢⱼ⁴ corresponds to the energy loss of a classical charge-induced dipole interaction between the charge of atom i and the dielectric medium that is displaced by atom j, Qiu D., Shenkin P. S., Hollinger F. P., Still W. C., J. Phys. Chem. A, 101, 3005 (1997). One can think of this as a first order approximation to the exact integral of equation (6). In fact, the Vⱼ/rᵢⱼ⁴ relationship for the contribution of atom j to the self-energy of atom i will hold only asymptotically, for large distances rᵢⱼ. At the same time, the true volume of atom j in the solute is different than the van der Waals volume Vⱼ since the atoms intersect each other. This is the reason that the parameters of the model need to be fitted to numerical solutions of the PB equation, and this makes application of (7) to large molecule systems difficult. For example, in order to use this model for proteins and nucleic acids, a re-parameterization was necessary, Dominy B. N., Brooks III C. L., J. Phys. Chem. B, 103, 3765 (1999). Again, those parameters will be applicable only for the molecule set that the parameters were trained on and the forcefield parameters used.

In the pair-wise descreening model, the polar solvation energy is calculated using a slightly different but equivalent formula for the Born radii, Bashford D., Case D. A., Annu. Rev. Phys. Chem., 51, 129 (2000), Hawkins G. D., Cramer C. J., Truhlar D. G., Chem. Phys. Let., 246, 122 (1995):

$${α}_{k}^{- 1} = {\int }_{{R}_{k}}^{∞} \frac{A ( r , {\{ {r}_{{kk}^{′}} , {R}_{{k}^{′}} \}}_{all {k}^{′}} )}{4 π {r}^{4}} ⅆ r \qquad ( 8 )$$

where A(r,{r_{kk′}, R_{k′}}_{all k′}) is the exposed surface area of a sphere of radius r centered at atom k and is intersected by all the other spheres k′ of radius R_{k′}, centered at the locations of all the other atoms k′ at distance r_{kk′}, from atom k, Hawkins G. D., Cramer C. J., Truhlar D. G., Chem. Phys. Let., 246, 122 (1995). Again, the integral in equation (8) cannot be calculated analytically because the atomic spheres k′ overlap with each other. These factors are less than one so that each sphere is reduced to an effective volume. The final formula for the Born radii in this model has the form:

$${α}_{k}^{- 1} = {R}_{k}^{- 1} - {\sum }_{{k}^{′}} H ( {r}_{{kk}^{′}} , {S}_{{k}^{′}} {R}_{k} ) \qquad ( 9 )$$

where H (r_{kk′}, S_{k′}Rₖ) is a complex expression, Hawkins G. D., Cramer C. J., Truhlar D. G., Chem. Phys. Let., 246, 122 (1995). The scaling factors S_{k′} are determined from fitting the solvation energies predicted by the PDA model to the numerical solutions of the PB equation, for a set of small molecules.

Although this method provides for an analytical approximation to the Born radii, the dependence on scaling factors and fittings to numerical solutions cause application of this method to other molecular systems difficult. Different parameterizations of the model have to be developed for it to be applicable to different systems, Hawkins G. D., Cramer C. J., Truhlar D. G., J. Phys. Chem., 100, 19824 (1996), Tsui V., Case D. A., J. Am. Chem. Soc., 122, 2489 (2000). There have been attempts to improve on the results of the PDA model, Onufriev A., Bashford D., Case D. A., J. Phys. Chem. B, 104, 3712 (2000), but the main drawback of the dependence of the results on empirically determined scaling factors remains.

In the SGB model, Ghosh, A., Rapp C. S., Frisner R. A., J. Phys. Chem. B, 102, 10983 (1998), the Born radii are calculated using the surface integral formula for the polarization self-energy of solvation, instead of the volume integral (6). The two expressions are formally equivalent but the surface integral has the advantage of being faster to calculate numerically than the volume integral. By creating a triangulation of the surface of the solute, we can calculate the contribution to the Born radius at each surface element and add up to get the value of the integral over the solute. The advantage of this method is that the CPU time for the surface integration scales better than the volume numerical integration, as a function of the size of the solute, and there is no need for any parameterization or scaling factors. In practice, however, empirical short-range (involving atom-pairs whose spheres overlap) and long-range corrections (based on the amount of invagination of the molecular surface) are added to improve agreement with numerical solutions of the PB equation. Also, the accuracy of the method depends on the resolution of the grid used, and derivatives of the Born radii are not readily available.

In light of the foregoing deficiencies to solving Equation (6), we employ the following methodology. The integration region Ωₖ in the volume integral of equation (6) is the volume of the solute that is inaccessible to the solvent, V, minus the volume of a sphere of radius Rₖ centered at \vec{r}ₖ. The solute volume is defined as the interior of the solvent accessible surface, which in turn is defined by the van der Waals spheres of each atom extended by the probe radius of the solvent, rₚ. We can partition the integration region into the set of sub-volumes V_{k′} that each neighboring atom k′ occupies and then rewrite the integral as a sum of the integrals over each sub-volume:

$${\int }_{{Ω}_{k}}^{} \frac{1}{{\vert {r}^{->} - {{r}^{->}}_{k} \vert}^{4}} {ⅆ}^{3} r = {\sum }_{{k}^{′} \neq k} {\int }_{{V}_{{k}^{′}}}^{} \frac{1}{{\vert {r}^{->} - {{r}^{->}}_{k} \vert}^{4}} {ⅆ}^{3} r \qquad ( 10 )$$

Equation (10) is exact as long as the partition of the integration region into sub-volumes is consistent, i.e.,

$${\sum }_{{k}^{′} \neq k} {V}_{{k}^{′}} = {Ω}_{k} .$$

However, the shape of the sub-volumes is highly irregular and the volume integrals in (10) cannot be solved analytically except in the simple case that V_{k′} is a sphere (it's not intersected by the neighboring atoms).

In particular, the integral of the quantity 1/|\vec{r}-\vec{r}ₖ|⁴ over the volume of a sphere of radius R_{k′}, centered at \vec{r}_{k′}, minus a possible overlap with the sphere (Rₖ,\vec{r}ₖ), can be solved analytically, Schaefer M., Froemmel C., J. Mol. Biol., 216, 1045 (1990):

While Equation (10) may be solved for the simple case of non-overlapping spheres, in reality though, atoms intersect. Accordingly, we further assume that we can define for the true sub-volume Vₖ, of each atom k in the solute, an effective radius Rₖ^{eff} such that the volume of a sphere of radius Rₖ^{eff} is equal to the true sub-volume Vₖ:

$${R}_{k}^{eff} = \sqrt[3]{\frac{3 {V}_{k}}{4 π}} \qquad ( 11 )$$

Then, we perform the volume integration in equation (10) analytically where each integration region is a sphere of radius R_{k′}^{eff}. Effectively, in this approximation we assume that the atoms are not overlapping, but the spherical volumes that we assign to each atom have been corrected for the overlap.

Since the method for the calculation of the true sub-volumes Vₖ is analytical, then the final formula for the Born radii is also analytical and we also now have the capability to calculate the full gradient of the polar solvation energy. Further, since methods according to the invention for calculating the volume of the solute is analytical, both the methods according to the invention for determining solute volumes and the methods according to the invention for determining solvation energies are computationally efficient. We refer to the methods according to the invention for calculating solvation energies as the “Analytical Volume Generalized Born” (AVGB) model .

### SUMMARY OF THE INVENTION

The present invention relates to methods for analytically determining the molecular volume and surface area of a solvated solute molecule and their application in efficiently determining solvation energies. To calculate solvation energies from Equations (1), (2), (6) and (10), it is necessary to be able to efficiently determine the volume and surface area of a solvated solute molecule. Accordingly, one aspect of the instant invention is a general method for analytically determining the volume of a solvated solute molecule comprising a plurality of atoms comprising the steps of: 1) modeling a solute as a set of fused spheres; 2) decomposing the set of fused spheres into a plurality of discrete polyhedral sub-volumes wherein each sub-volume corresponds to an atom in the fused sphere; 3) selecting a particular polyhedral sub-volume; 4) decomposing the selected polyhedral sub-volume into a plurality of cone-pyramids and a spherical sector; 5) determining the total volume of the plurality of cone-pyramids and the spherical sector produced by the decomposition of the selected polyhedral sub-volume using the Gauss-Bonnet theorem and the coordinate system in FIG. 12; 6) repeating steps 3-5 for each polyhedral sub-volume produced by the decomposition in step 2 and 7) determining the volume of the set of fused spheres by summing quantities determined in step 6.

Performing step 5)—applying the GB theorem in combination with the coordinate system shown in FIG. 12—inherently requires identifying and ordering the GB arcs in order to efficiently calculate the exposed surface area of each atom. Since the topologies that may arise in a molecular simulation can vary greatly and can be extremely complex it is important than any automated method for determining molecular volumes and surface area be sufficiently robust and efficient to deal with all possible topologies.

Accordingly, another aspect of the invention is an improved method for determining which atoms in the solute create particular GB arcs on the surface of a central atom and further determining what is the order of those arcs comprising the steps of: 1) partitioning the simulation space into a regular array of cells and assigning each atom in the solute a cell; 2) determining which atoms intersect a particular atom chosen to be central atom; and 3) determining which intersecting atoms to the central atom limit its exposed surface area and their connectivity.

A still further aspect of the invention, in an improved method for determining the surface area of a solute comprising the steps of: 1) determining the exposed surface area of each atom in a solvated solute using the GB theorem and the coordinate system in FIG. 12 in combination with the methods according to the invention for identifying and ordering GB arcs and 2) summing the exposed surface area of each atom in the solvated solute to determine the surface area for the solvated solute as a whole.

A still further aspect of the invention is an improved method for determining a born radii using equations (6) and (10) in combination with methods according to the invention for determining a molecular volume.

Yet another aspect of the invention is a computer system comprising programming for the methods according to the invention.

### BRIEF DESCRIPTION OF THE FIGURE

FIG. 1 illustrates an example of the fused-sphere model: The central atom (white) is surrounded by a number of neighbors that define its exposed surface area and volume

FIG. 2 illustrates the solvent accessible surface (transparent) of 3 carbon atoms with radius 1.7 Å (gray), as is traced by a probe of radius 1.4 Å (yellow.).

FIG. 3 illustrates two intersecting spheres and the circle of intersection (COI.).

FIG. 4 illustrates three intersecting spheres. The COI's intersect with each other.

FIG. 5 illustrates two intersecting spheres, i and k, separated by the separating plane. The distance between the separating plane and the center of sphere i is gₖ.

FIG. 6 illustrates three intersecting spheres and the corresponding separating planes for the central sphere (red.)

FIG. 7 illustrates the decomposition of the fused-sphere model into the building blocks that correspond to each atom in a method according to the invention.

FIG. 8 illustrates the building block and the planar sections formed by the neighbors in a method according to the invention.

FIG. 9 illustrates a decomposition of a building block into cone-pyramids and a spherical sector employed in a method according to the invention.

FIG. 10 illustrates a decomposition of a planar section into triangles and arc-sectors employed in a method according to the invention.

FIG. 11 illustration of the Application of the Gauss-Bonnet theorem on the surface of sphere i, intersected by neighbors j, k, l. (Figure adapted from reference, Frazkiewicz R., Braun W., J. Comp. Chem., 19, 319 (1998).)

FIG. 12 illustrates a parameterization of the Gauss-Bonnet arcs used in a method according to the invention. In this example, the central atom i is intersected by three neighbors, j, k, l. The i-j and i-k COI's intersect each other, as the i-k and i-l do also. See text for explanation of the vector quantities. (Figure adapted from reference, Frazkiewicz R., Braun W., J. Comp. Chem., 19, 319 (1998).)

FIG. 13 illustrates a partition of the simulation space into cells used in a method according to the invention. For each atom we search the cell the atom belongs to (dark gray) and the 26 neighboring cells (light gray.)

FIG. 14 illustrates an exemplary 4 atom solute. The central atom (red) is intersected by the neighbors A, B and C (green). Neighbor B is occluded by A and C.

FIG. 15 illustrates the intersecting planes of each neighbor for the molecule shown in FIG. 14.

FIG. 16 illustrates the intersecting plane between the central atom (left) and a neighbor.

FIG. 17 illustrates the two half-spaces H₁ and H₂ defined by the intersecting plane. The exposed area and excluded volume of the central atom is on H₁.

FIG. 18 illustrates the example of a swallower: the neighbor (green) “swallows” the central atom (white) but not completely.

FIG. 19 illustrates the half-spaces defined in the case of a swallower neighbor (right). The exposed area and excluded volume of the central atom (left) is on half-space H₁.

FIG. 20 illustrates the IHS for the example of FIG. 14. The half-spaces of neighbors A, B and C that include the central atom's exposed area and excluded volume are colored blue, red and yellow respectively. The overlap of the half-spaces is colored by the corresponding overlapping color, i.e., yellow+red=orange, blue+red=purple, blue+yellow=green. The common interior of the constraints is the IHS (green) and it is only due to the A and C half-spaces. Neighbor B is occluded.

FIG. 21 illustrates an exemplary convex hull for a set of points in two dimensions.

FIG. 22 illustrates an exemplary set of linear constraints.

FIG. 23 illustrates the normals to the constraints shown in FIG. 22.

FIG. 24 illustrates the dual points of the constraint planes shown in FIG. 22.

FIG. 25 illustrates the convex hull of the dual points shown in FIG. 24.

FIG. 26 illustrates the normal vectors to the faces of the convex hull shown in FIG. 25.

FIG. 27 illustrates the dual points of the faces of the convex hull shown in FIG. 25.

FIG. 28 illustrates a connection of the dual points of the convex shown in FIG. 27.

FIG. 29 illustrates the resulting Intersection of Half Spaces (IHS) shown for the example in FIGS. 21-28.

FIG. 30 illustrates the IHS polyhedron formed by the neighbors of the central atom (white) for the example in FIG. 1.

FIG. 31 illustrates the IHS polyhedron of FIG. 30 as it cuts through the central atom.

FIG. 32 illustrates the IHS polyhedron of FIG. 30.

FIG. 33 illustrates an exemplary buried-buried edge.

FIG. 34 illustrates an exemplary buried-exposed edge.

FIG. 35 illustrates an exemplary exposed-exposed intersecting edge.

FIG. 36 illustrates an exemplary exposed-exposed non-intersecting edge.

FIG. 37 illustrates an exemplary buried IHS vertex corresponding to three connected neighbors and three GB-points.

FIG. 38 provides a two-dimensional representation of buried IHS vertex shown in FIG. 37.

FIG. 39 illustrates an exemplary exposed IHS vertex corresponding to three disjoint neighbors and three GB-points.

FIG. 40 provides a two dimensional representation of the exposed IHS vertex shown in FIG. 39.

FIG. 41 illustrates an exemplary topology of 7 neighbor atoms about a central atom.

FIG. 42 illustrates the connectivity graph for the example of FIG. 41. The oriented edges correspond to GB-points.

FIG. 43 illustrates a connectivity table for the example of FIG. 41

FIG. 44 illustrates an exemplary ordering of GB arcs. Traversing the connectivity graph of FIG. 41: starting from the GB-point A on neighbor 5, the next GB-point has to be on neighbor 1. Out of the three possibilities B, C, D, the GB-point B is the correct choice.

FIG. 45 illustrates the GB-paths for the example of FIG. 41.

FIG. 46 illustrates the selected cycles (the GB-paths) of the connectivity graph for the example of FIG. 41 The two GB-paths are: 5-1-2-6-7-3-8-4-1-5 and 1-3-7-6-2-1.

FIG. 47 illustrates the relationship of the planar sections of the building block of FIG. 8 with the IHS and the GB-paths.

FIG. 48 illustrates the linear scaling of the CPU time for area/volume calculation using the methods according to the invention with respect to the number of atoms in the system.

FIG. 49 illustrates a comparison of the polar solvation energies between Delphi and UHBD for the molecule set of Table 6 in FIG. 75. The RMS difference is 0.62 Kcal/Mol.

FIG. 50 illustrates a comparison of the polar solvation energies between PBF and UHBD for the molecule set of Table 6 in FIG. 75. The RMS difference is 0.41 Kcal/Mol.

FIG. 51 illustrates a comparison of the polar solvation energies between PBF and Delphi for the molecule set of Table 6 in FIG. 75. The RMS difference is 0.73 Kcal/Mol.

FIG. 52 illustrates a comparison of the polar salvation energies between AVGB and UHBD for the molecule set of Table 6 in FIG. 75. The RMS difference is 1.79 Kcal/Mol.

FIG. 53 illustrates a comparison of the polar solvation energies between SGB and UHBD for the molecule set of Table 6 in FIG. 75. The RMS difference is 1.93 Kcal/Mol.

FIG. 54 illustrates a comparison of AVGB with εᵢₙ=1.3 to UHBD with εᵢₙ=1.0 for the molecule list of Table 6 in FIG. 75. The RMS difference is 0.46 Kcal/Mol.

FIG. 55 illustrates a comparison of AVGB and UHBD with εᵢₙ=1.0, for the proteins of Table 1. The RMS difference is 1169 Kcal/Mol.

FIG. 56 illustrates a comparison of AVGB with εᵢₙ=1.3 and UHBD with εᵢₙ=1.0, for the proteins of Table 1. The RMS difference is 303 Kcal/Mol.

FIG. 57 illustrates a THF dimer with the polar parts facing each other.

FIG. 58 illustrates the polar solvation energy for the system of FIG. 57 from AVGB as a function of the distance between the two THF molecules. The red line shows the energy when the molecules are infinitely separated from each other.

FIG. 59 illustrates a THF dimer with the polar parts away from each other.

FIG. 60 illustrates the polar solvation energy for the system of FIG. 59 from AVGB as a function of the distance between the two THF molecules. The red line shows the energy when the molecules are infinitely separated from each other.

FIG. 61 illustrates a comparison between the experimental and predicted water solvation energies for the AVGB-SAS salvation model, using solvation types by element. The different chemical groups are shown.

FIG. 62 illustrate a comparison between the experimental and predicted water solvation energies for the AVGB-SAS solvation model, using the solvation types of Table 3. The different chemical groups are shown.

FIG. 63 illustrates total calculation times for the AVGB-SAS model for a system of 3401 atoms, for different platforms. The contributions of the different parts of the calculation are shown.

FIG. 64 illustrates the scaling of the AVGB-SAS method as a function of the size (number of atoms) of the molecular system. The calculations were performed on an Intel Pentium III 866 MHz.

FIG. 65 illustrates a comparison of CPU time spent for calculating the solvation energy of 1 mcp between SGB and AVGB, for three different platforms.

FIG. 66 illustrates the parallel scaling of AVGB-SAS on a shared memory symmetric 4-processor Intel Pentium III Xeon 550 MHz, for a 3401 atom protein (1 mcp.)

FIG. 67 illustrates the sensitivity of the AVGB-SAS energy with the update frequency of the Born radii. The test was performed on a small protein (4pti, 454 atoms) for 200 steps.

FIG. 68 illustrates thermodynamic cycle for the calculation of the binding energy of a receptor-ligand complex in solution.

FIG. 69 illustrates the initial structure of B-DNA in a simulation.

FIG. 70 illustrates the structure of the B-DNA after 80 ps in vacuum with free tips.

FIG. 71 illustrates the structure of the B-DNA after 80 ps in implicit solvent with free tips.

FIG. 72 illustrates the structure of the B-DNA after 80 ps in vacuum with fixed tips.

FIG. 73 illustrates the structure of the B-DNA after 80 ps in implicit solvent with fixed tips.

FIG. 74 illustrates the RMSD of non-hydrogen atoms between simulation snapshots and the canonical B-DNA, for vacuum and solvent simulations using AVGB-SAS.

FIG. 75 contains a tabular list of the small molecule used in the example calculations.

### DETAILED DESCRIPTION OF THE INVENTION

### 1. Methods of Calculating Molecular Volumes

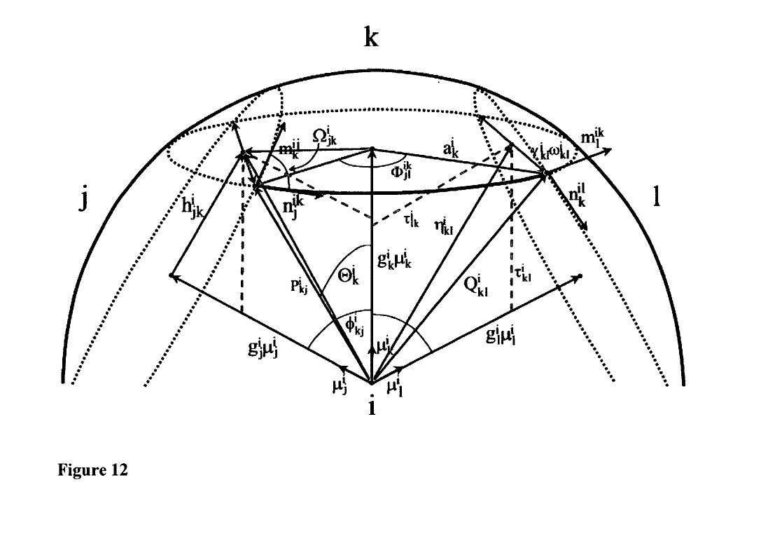

A method according to the invention for calculating the molecular volume of a solvated solute comprises the steps of: 1) modeling a solute as a set of fused spheres; 2) decomposing the set of fused spheres into a plurality of discrete polyhedral sub-volumes wherein each sub-volume corresponds to an atom in the fused sphere; 3) selecting a particular polyhedral sub-volume; 4) decomposing the selected polyhedral sub-volume into a plurality of cone-pyramids and a spherical sector; 5) determining the total volume of the plurality of cone-pyramids and the spherical sector produced by the decomposition of the selected polyhedral sub-volume using the Gauss-Bonnet theorem and the coordinate system in FIG. 12; 6) repeating steps 3-5 for each polyhedral sub-volume produced by the decomposition in step 2 and 7) determining the volume of the set of fused spheres by summing quantities determined in step 6.

1.1 Methods for Modeling a Solute as a Set of Fused Sphere

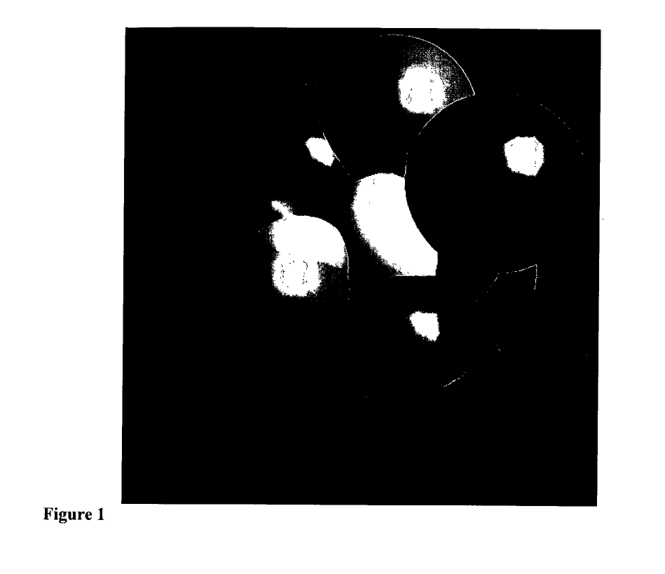

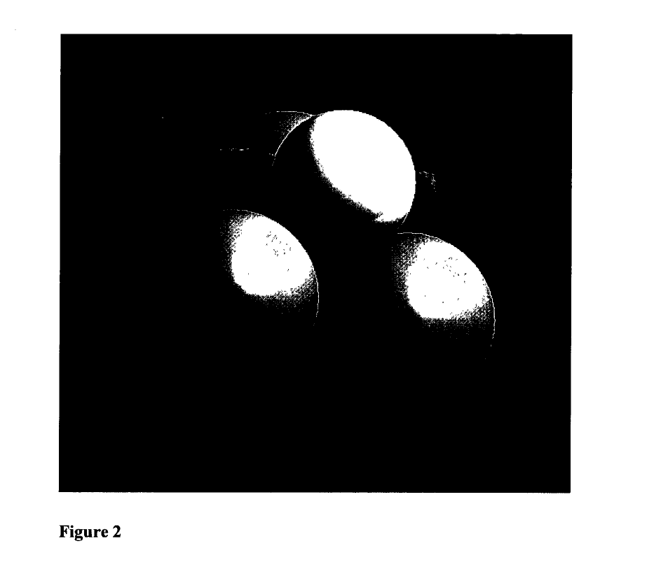

A molecule represented as a set of fused spheres, is shown in FIG. 1. In this representation each atom in the solute is represented as a sphere and the solute as a group of interconnecting spheres. In one fused sphere model representation, the radius of each sphere (or each atom) is equal to the van der Waals of the atom it represents rᵢ^{vdW}. In an alternative fused sphere reprentation, based upon the solvent accessible surface area (SASA), the radius of each sphere is equal to its van der Waals radius, rᵢ^{vdw} extended by the probe radius of the solute, rₚ, i.e., rᵢ=rᵢ^{vdW}+rₚ. In this model, illustrated in FIG. 2 the radii of the atoms are extended by the probe radius. The solvent accessible surface is the surface traced by the center of a spherical solvent probe, as it rolls around the van der Waals spheres of the solute. In general, the methods according to the invention for calculating molecular volumes and surface areas are completely general with regard to how atomic radii are assigned to the atoms of a solute molecule.

1.2 Decomposing the Set of Fused Spheres Into a Plurality of Polyhedral Sub-volumes

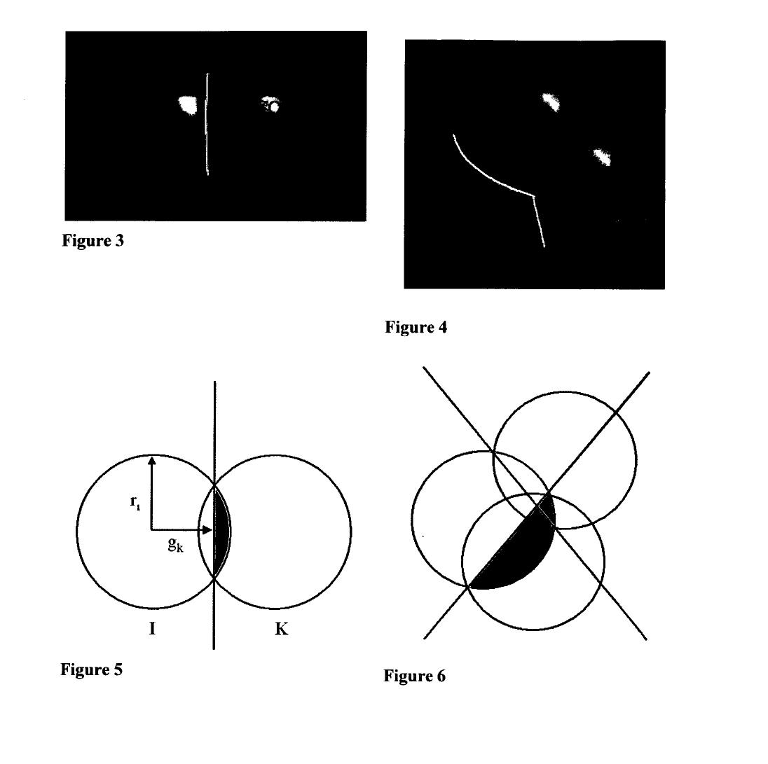

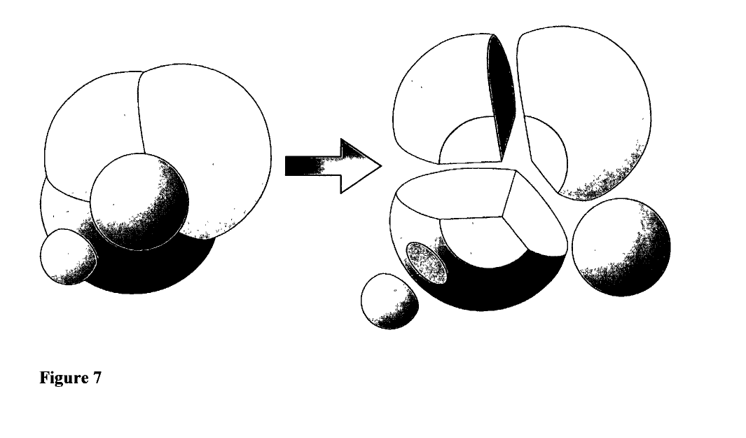

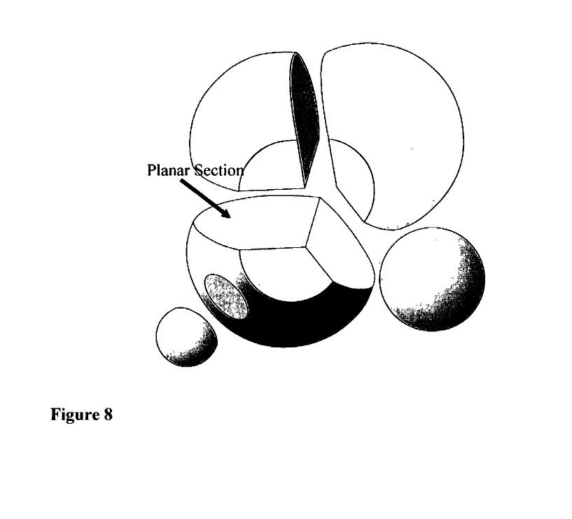

In order to robustly calculate the individual sub-volumes we need a method that unambiguously decomposes a set of fused spheres into their sub-volumes. The simplest case of two overlapping spheres, as is illustrated in FIG. 3 can give us the principle of the decomposition: the two spheres intersect each other and form a circle on the boundary, the circle of intersection (COI) (FIG. 3). The COI, as is shown in FIG. 5 defines a separating plane that cuts through the spheres. The intersection of the separating plane with the surface of each sphere is the COI. If there are more than two spheres, the separating planes might intersect each other, forming a more complicated topology. For example as is shown in FIGS. 4 and 6, the circles of intersection intersect each other (FIG. 4), as the separating planes do also.

The intersecting planes that cut through the spheres separate the fused-sphere model into building blocks. Each building block is a complicated geometrical shape that is made of a sphere that has been cut by the corresponding intersecting planes from each neighbor. FIG. 7 illustrates the decomposition of a fused-sphere model into the building blocks used in the volume determining methods according to the invention. The building blocks consist of planar faces and regions of the sphere surface that are left uncut.

1.3 Decomposing Each Polyhedral Sub-volume Into a Plurality of Cone-pyramids and a Spherical Sector

In order to calculate the volume of the building blocks we need to continue the decomposition process hierarchically, until we are able to describe the objects from well-defined geometrical shapes. The building block is made from the atom's sphere cut by the intersecting planes between the atom and its neighbors. As is shown in FIG. 8, these cuts are planar sections on the surface of the block and they correspond to the neighbor that formed them.

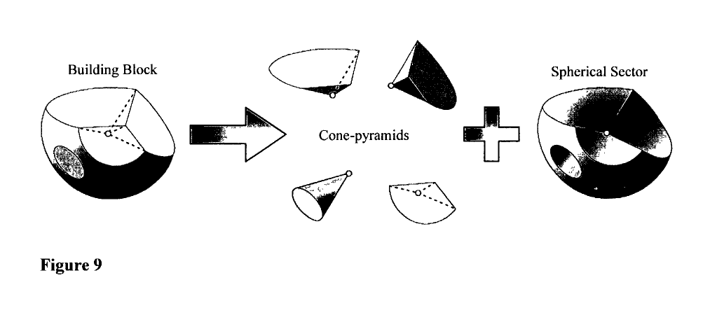

If we connect each point on a planar section to the center of the sphere we form a solid that has the shape of a cone-pyramid with the planar section as its base. If we “carve” out all the cone-pyramids from the building block, we are left with a spherical sector. The spherical sector is the solid that results by connecting all points of the exposed surface of the atom (the spherical part of the building block) to the center of the sphere. This cone-pyramid decomposition was proposed in Dodd L. R., Theodorou D. N. Mol. Phys., 82, 1313 (1991) and is illustrated in FIG. 9.

1.4 Determining the Total Volume of the Plurality of Cone-pyramids and the Spherical Sector Produced by the Decomposition of a Particular Polyhedral Sub-volume Using the Gauss-Bonnet Theorem and the Coordinate system in FIG. 12.

The advantage of this decomposition is that the volume of cone-pyramids and spherical sectors can be calculated analytically. If a cone-pyramid has a base of area A and distance from the tip d, then the volume is

$${V}_{con \text{-} pyr} = \frac{1}{3} Ad .$$

Similarly, the volume of the spherical sector of radius r is the sum of the volumes of infinitesimal pyramids of base area ds:

$${V}_{sph \text{-} sec} = \int ⅆ V = \int \frac{1}{3} r ⅆ s = \frac{1}{3} rS \qquad ( 72 )$$

Thus, the volume of the spherical sector is proportional to the exposed area of the atom. In general, for the building block of an atom i with radius rᵢ and exposed surface area Sᵢ^{exp}, formed by j={1, . . . , M} neighbors that are separated from i by planes of distance gᵢⱼ from the center of i, the volume Vᵢ is given by

$${V}_{i} = \frac{1}{3} {r}_{i} {S}_{i}^{exp} + {\sum }_{j = 1}^{M} \frac{1}{3} {g}_{ij} {A}_{ij} \qquad ( 13 )$$

where Aᵢⱼ is the area of the planar section that is fonned on atom i from neighbor j. Note that in equation (13) the distance gᵢⱼ of the separating plane of neighbor j from atom i can be negative if the neighbor “swallows” the atom; that is, the center of i is buried by j. See FIG. 5. The algebraic sum subtracts correctly the overlaps that may appear between the cone-pyramids in the case of a swallower neighbor. See Irisa M., Comp. Phys. Comm., 98, 317 (1996).

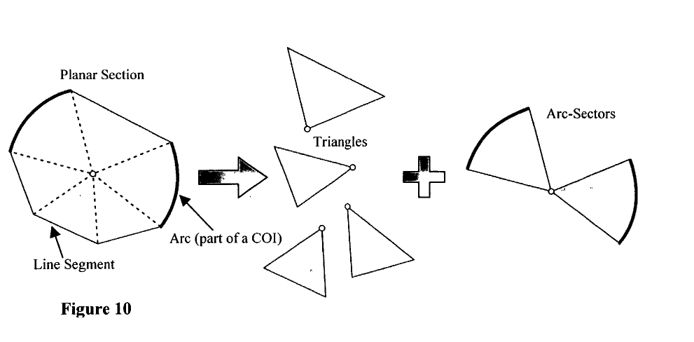

As is shown in FIG. 10, the area of a planar section, Aᵢⱼ, between atom i and neighbor j can be calculated in a similar fashion by decomposing it into triangles and arc-sectors. In general, the planar section is bounded by a set of arcs and line segments. The arcs are parts of the COI formed between i and neighbor j. The line segments correspond to intersections of the atom and neighbor with other neighbors k of the atom. They are formed by the intersections of the atom-neighbor plane with the other neighbors' intersection planes. For the decomposition, we need to pick a reference point on the surface of the i-j intersecting plane that will define the triangles and arc-sectors. This point is defined to be the intersection between the line that connects the centers of i and j, and the intersection plane. The connecting line is normal to the intersection plane. Thus, if we have Mᵢⱼ^{arcs} on the planar section and Mᵢⱼ^{seg} line segments, then the planar section's area is

$${A}_{ij} = {\sum }_{λ = 1}^{{M}_{ij}^{arcs}} \frac{1}{2} {a}_{ij} {S}_{λ} + {\sum }_{μ = 1}^{{M}_{ij}^{seg}} \frac{1}{2} {h}_{μ} {t}_{μ} \qquad ( 14 )$$

where S_{λ} is the length of the λ^{th} arc on the planar section, aᵢⱼ is the radius of the i-j COI, t_{μ} is the length of the μ^{th} line segment and h_{μ}, the distance between the reference point and the line segment.

Equations (13) and (14) allow us to calculate the volume of the building blocks and thus the volume of each atom accurately, as long as we can calculate the exposed surface area Sᵢ^{exp} and all the other quantities, gᵢⱼ, aᵢⱼ, t_{μ}, h_{μ}. The next section presents a method to determine the exposed areas Sᵢ^{exp} using the Gauss-Bonnet theorem

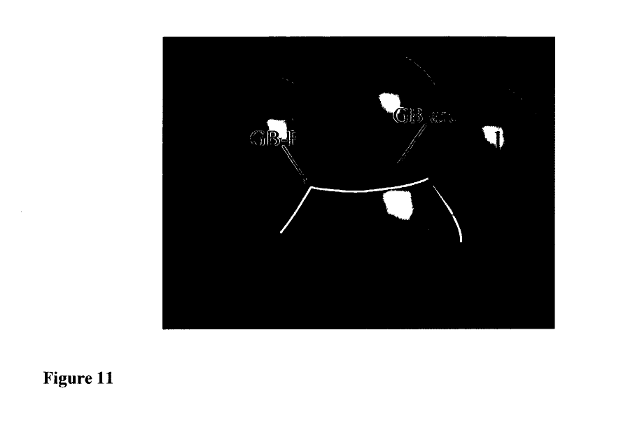

As FIG. 11 illustrates, in a fused sphere model, intersecting neighbor atoms form circles of intersection, (COIs), on the sphere of atom i. One method according to the invention for determining the exposed surface area of a fused surface represented molecule comprises the steps of: 1) determining the buried surface area of atom i and 2) determining the exposed surface area of atom i from the buried surface area. Although the buried surface area of atom i may be determined by any method known in the art, it may be advantageously determined by applying the GB theorem to atom i.

As is shown in FIG. 11, the buried surface of i is bounded by arcs which are pieces of the COIs. We name these arcs the Gauss-Bonnet arcs (GB-arcs) and the closed oriented path that bounds the buried surface the Gauss-Bonnet path (GB-path). For the λ^{th} arc, the arc length may be represented by Φⁱ_{λ}. The radius of the corresponding COI may be represented by aⁱ_{λ} and the polar angle of the COI may be represented by Θⁱ_{λ}; the exterior angle between arc λ and λ+1 may be represented by Ωⁱ_{λ}. The gaussian curvature of the sphere of radius rᵢ is provided by K=1/rᵢ². In order to calculate the geodesic curvature of the arc, we apply the GB theorem on a spherical cap of height rᵢ-dⁱ_{λ} and radius aⁱ_{λ} on the base. For a spherical cap, because the area is 2πrᵢ (rᵢ-dⁱ_{λ}) and χ=1, we have

$$\begin{matrix}{k}_{g}^{λ} 2 π {a}_{λ}^{i} + 2 π {r}_{i} ( {r}_{i} - {d}_{λ}^{i} ) \frac{1}{{r}_{i}^{2}} = 2 π \\ hence \\ {k}_{g}^{λ} = \frac{{d}_{λ}^{i}}{{r}_{i} {a}_{λ}^{i}}\end{matrix} \qquad ( 15 )$$

Then, since cos Θⁱ_{λ}=dⁱ_{λ}/rᵢ, the geodesic curvature of the λ arc must be

$${k}_{g}^{λ} = \frac{cos {Θ}_{λ}^{i}}{{a}_{λ}^{i}} \qquad ( 16 )$$

By applying the GB theorem on the surface buried by the neighbors of atom i and using (16), we get the buried surface area:

$$\begin{matrix}{\sum }_{λ = 1}^{P} \frac{cos {Θ}_{λ}^{i}}{{a}_{λ}^{i}} {Φ}_{λ}^{i} {a}_{λ}^{i} + {S}_{i}^{Buried} \frac{1}{{r}_{i}^{2}} + {\sum }_{λ = 1}^{P} {Ω}_{λ}^{i} = 2 π χ \\ hence \\ {S}_{i}^{Buried} = {r}_{i}^{2} [ 2 π χ - {\sum }_{λ = 1}^{P} ( {Ω}_{λ}^{i} + {Φ}_{λ}^{i} cos {Θ}_{λ}^{i} ) ]\end{matrix} \qquad ( 17 )$$

The Euler-Poincare characteristic χ, describes the topology of a buried surface formed from intersecting spheres. Such a buried surface is topologically equivalent to a sphere with n holes where each hole is formed from a closed path defined by the respective centers of intersection for each of the neighbor spheres. Hence χ=2-n. However, in general, there may be multiple portions of the surface of an atom that may be buried due to discrete sets of overlapping neighbor atoms. Accordingly,

$$χ = {\sum }_{z} {x}_{z} ,$$

where χ_{z} refers

to the Euler-Poincare characteristic for a contiguous set of overlapping neighbors that define a discrete buried surface area z.

In a second step in a method according to the invention the exposed area of atom i may be calculated by substracting the buried surface area of atom i, given by equation (17), from the total surface area 4πrᵢ²:

$${S}_{i}^{exp} = {r}_{i}^{2} [ 2 π ( 2 - χ ) - {\sum }_{λ = 1}^{P} ( {Ω}_{λ}^{i} + {Φ}_{λ}^{i} cos {Θ}_{λ}^{i} ) ] \qquad ( 18 )$$

where now χ is the sum of the individual χ's for each disconnected piece of the buried surface and P is the total number of GB-arcs on the surface of the atom. Using the GB theorem, the calculation of the exposed area is reduced to the calculation of the arcs of the COI's of the neighbors on the surface of the atom, their respective ordering, and the angles between them. In principal any coordinate system may be used to parameterize these quantities. For example, although a Cartesian coordinate system may be employed, the final formulas are cumbersome. A more preferable coordinate system is illustrated in FIG. 12. We will use the center of the central atom i, in FIG. 12, as the center of the coordinate system. If atom i of radius rᵢ is located at \vec{x}ᵢ and its neighbor k of radius rₖ at \vec{x}ₖ, then the distance from the center of i to the COI that is formed by k may be represented as gₖⁱ, where

$$\begin{matrix}{\hat{μ}}_{k}^{i} = {{x}^{->}}_{k} - {{x}^{->}}_{i} / \vert {{x}^{->}}_{k} - {{x}^{->}}_{i} \vert \\ and \\ {g}_{k}^{i} = \frac{{\vert {{x}^{->}}_{k} - {{x}^{->}}_{i} \vert}^{2} + {r}_{i}^{2} - {r}_{k}^{2}}{2 \vert {{x}^{->}}_{k} - {{x}^{->}}_{i} \vert}\end{matrix} \qquad ( 19 )$$

and the radius of the COI, aₖⁱ, may be represented as

aₖⁱ=\sqrt{rᵢ²−(gₖⁱ)²} (20)

Accordingly, the polar angle Θⁱₖ of the COI is

cos Θⁱₖ=gₖⁱ/rᵢ (21)

Now, if the neighbor k is intersected by two other neighbors, j and l, as is shown in FIGS. 11-12, the i-k COI is intersected by the i-j and i-l COIs (located at gⁱⱼ\hat{μ}ⁱⱼ and gₗⁱ\hat{μ}ₗⁱ respectively) and the visible subsection of the i-k COI becomes a GB-arc. The orientation of the GB-Path is noteworthy because depending on this orientation the calculation of the buried area, equation (18), will yield the area on one or the other side of the GB-path. The proper orientation for the GB-arcs shown in FIG. 12, looking from above (outside the central atom) in FIG. 12, is counterclockwise (CCW). Accordingly, the k GB-arc is bounded by two points, \vec{P}ₖⱼⁱ and \vec{Q}ₖₗⁱ, that are the intersection points between the i-k and i-j COIs and i-k and i-l COIs respectively. We call these points “GB-points.” If the midpoint of the segment defined by the intersection of the i-k and i-j COIs is \vec{η}ₖⱼⁱ, 2γₖⱼⁱ is the total length of the segment and \vec{ω}ᵢₖⱼ the unit vector on the direction of the segment, then the following relationships apply:

$$cos {φ}_{kj}^{i} = {\hat{μ}}_{k}^{i} \cdot {\hat{μ}}_{j}^{i} \\ {{η}^{->}}_{kj}^{i} = {τ}_{kj}^{i} {\hat{μ}}_{k}^{i} + {τ}_{jk}^{i} {\hat{μ}}_{j}^{i} \\ {τ}_{kj}^{i} = \frac{{g}_{k}^{i} - {g}_{j}^{i} cos {φ}_{kj}^{i}}{{sin}^{2} {φ}_{kj}^{i}} \\ {\hat{ω}}_{ikj} = \frac{{\hat{μ}}_{k}^{i} \times {\hat{μ}}_{j}^{i}}{sin {φ}_{kj}^{i}} \\ {γ}_{kj}^{i} = \sqrt{{r}_{i}^{2} - {g}_{k}^{i} {τ}_{kj}^{i} - {g}_{j}^{i} {τ}_{jk}^{i}} \qquad ( 22 )$$

where φₖⱼⁱ is the angle between the i-k and i-j COIs. From these relationships the GB-points may be determined from:

\vec{P}ₖⱼⁱ=\vec{η}ₖⱼⁱ+γₖⱼⁱ\hat{ω}ᵢₖⱼ

\vec{Q}ₖₗⁱ=\vec{η}ₖₗⁱ−γₖₗⁱ\hat{ω}ᵢₖₗ (23)

with the tangent unit vectors that define the exterior angles Ω between consecutive GB-arcs,

$${\hat{n}}_{j}^{ik} = \frac{{\hat{μ}}_{k}^{i} \times {{P}^{->}}_{kj}^{i}}{{a}_{k}^{i}} \\ {\hat{m}}_{l}^{ik} = \frac{{\hat{μ}}_{k}^{i} \times {{Q}^{->}}_{kl}^{i}}{{a}_{k}^{i}} \\ {Ω}_{jk}^{i} = - arccos ( {\hat{n}}_{j}^{ik} \cdot {\hat{m}}_{k}^{ij} ) \qquad ( 24 )$$

since the exterior angles are negatively oriented. The angular arc length of the GB arc can be calculated from the inner product of the vectors \vec{n}ⱼ^{ik} and \vec{m}ₗ^{ik}. The arc length is determined by calculating either the arc-cosine of the inner product or the complimentary angle. In compact form, this may be expressed

Φⱼₗ^{ik}=(1−Sⱼₗ^{ik})π+Sⱼₗ^{ik} arc cos (\vec{n}ⱼ^{ik}·\vec{m}ₗ^{ik})

where

Sⱼₗ^{ik}=sign (\hat{μ}ₖⁱ×(\vec{n}ⱼ^{ik}×\vec{m}ₗ^{ik})) (25)

Sⱼₗ^{ik} is the sign of the relative orientation of the vector \hat{μ}ₖⁱ and the tangent vectors \vec{n}ⱼ^{ik} and \vec{m}ₗ^{ik}. Thus, the arc-length of the i-k COI's GB-arc bounded by neighbors j and l may be represented as

Sⱼₗ^{ik}=aₖⁱΦⱼₗ^{ik} (26)

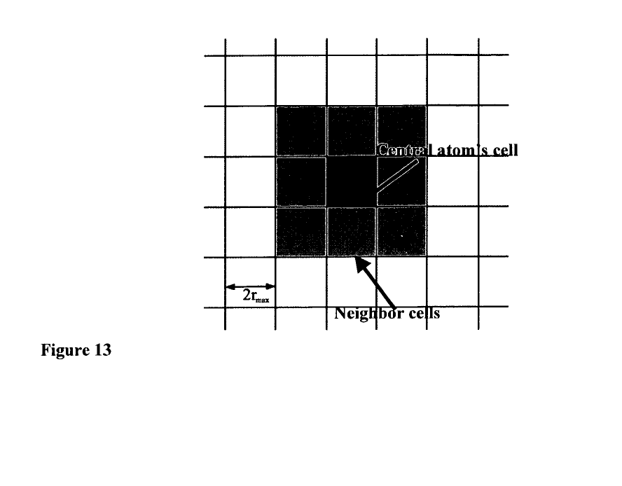

This equation represents the arc-length of each arc-sector in equation (14). Finally, for the planar section formed by neighbor k, since the reference point for the planar section is gₖⁱ\hat{μ}ₖⁱ, the base of a triangle in the decomposition corresponds to the line segment formed by the intersection of the COIs of the neighbors k and j that define it. Then, the height of the triangle, as is shown in FIG. 13, may be represented as

$${h}_{jk}^{i} = \frac{{g}_{k}^{i} - {g}_{j}^{i} cos {φ}_{kj}^{i}}{sin {φ}_{kj}^{i}} \qquad ( 27 )$$

and the length of the base, tⱼₖⁱ, can be determined by the positions of the vertices that define it. These vertices are the intersection points of three spheres, which might or might not include the central atom. See FIG. 8. If the central atom is included, then the vertex is the corresponding GB-point; otherwise it can be calculated analytically by employing the same vector parameterization that we have used in this section.

1.5 Determining the Solute Volume by Summing the Volume of Each Polyhedral Sub-volume Produced by the Decomposition in Section 1.2.

We may determine the volume of the fused sphere modeled solute by repeating the volume calculation made in Section 1.4 for each polyhedral sub-volume produced by the decomposition made in Section 1.2 and summing the respective sub-volumes. Similarly, the total solvated surface area may be determined by summing the exposed surface of each atom in the solute. We can differentiate these expressions with respect to each neighbor's coordinates to get partial gradients of these quantities. Since moving the central atom in one direction is equivalent to moving all the neighbors in the opposite direction, we can compute the gradient with respect to the central atom by summing the partial gradients with respect to its neighbors' positions. In particular, for the exposed surface area of atom i, Sᵢ^{exp}, if the central atom has Mᵢ neighbors, then

$$\frac{\partial {S}_{i}^{exp}}{\partial {{x}^{->}}_{i}} = - {\sum }_{k = 1}^{{M}_{i}} \frac{\partial {S}_{i}^{exp}}{\partial {{x}^{->}}_{i}} \qquad ( 28 )$$

The derivation of the partial gradients is tedious but straightforward and has been presented in Frankiewicz R., Braun W. J., Comp. Chem., 19, 319 (1998). The total gradient is the sum of the partial gradient with respect to the central atom and the partial gradient of the neighbors with respect to the central atom:

$${∇}_{i} {S}_{i}^{exp} = \frac{\partial {S}_{i}^{exp}}{\partial {{x}^{->}}_{i}} + {\sum }_{j = 1}^{{M}_{i}} \frac{\partial {S}_{i}^{exp}}{\partial {{x}^{->}}_{i}} \qquad ( 29 )$$

### 2. Methods For Determining and Identifying The Connectivity of Neighbors Intersecting a Particular Central Atom Which Limit its Exposed Surface Area

The disclosure in the above sections detail the formulas needed for the analytical calculation of areas and volume of a solvated solute for a fused sphere model. This assumes that we know for every atom in the model which neighbors intersect the atom and in which order. In particular, the application of the Gauss-Bonnet theorem implies that we know which neighboring atoms create the GB-arcs on the surface of the central atom and also the ordering of the GB-arcs as they form the closed GB-paths. Since the topologies that may arise in a molecular simulation can vary greatly and can be extremely complex it is important than any automated method for determining molecular volumes and surface area be sufficiently robust and efficient to deal with all possible topologies.

Accordingly, another aspect of the invention is a method for identifying the connectivity of the neighbors intersecting a particular central atom which limit the exposed surface area of the central atom comprising the steps of: 1) partitioning the simulation space into a regular array of cells and assigning each atom in the solute a cell; 2) determining which atoms intersect a particular atom chosen to be central atom; and 3) determining which intersecting atoms to the central atom limit its exposed surface area and their connectivity.

2.1 Partitioning the Simulation Space Into a Regular Array of Cells and Assigning Each Atom in the Solute to a Cell

In one embodiment of a method according to the invention for identifying intersecting neighbors, illustrated in FIG. 13, we assign each atom into the cell that contains it and then search which atoms intersect the central atom only for the cell it belongs to and the 26 neighboring cells. While this is an efficient method for determining a set of neighbors to a central atom, one skilled in art will recognize many similar methods may be applied including, generating an explicit neighbor list.

2.2 Determining Which Atoms Intersect a Particular Atom Chosen to be Central Atom

If the sphere of radius rᵢ+2rₘₐₓ centered on the central atom of radius rᵢ and a neighboring cell do not intersect, no atom in that cell can intersect the central atom. Thus, only if the neighboring cell and the rᵢ+2rₘₐₓ sphere intersect we search for intersecting atoms in that cell. In order for the search to be complete when we restrict ourselves to searching only the nearest neighbor cells, the length of each cell has to be at least twice the maximum radius in the system, rₘₐₓ.

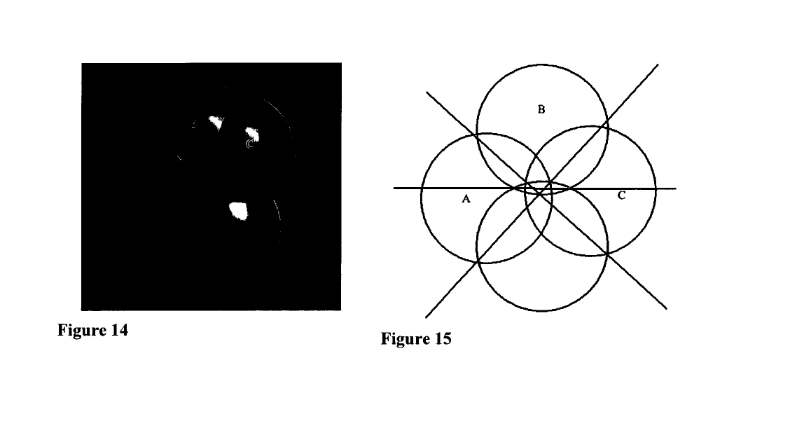

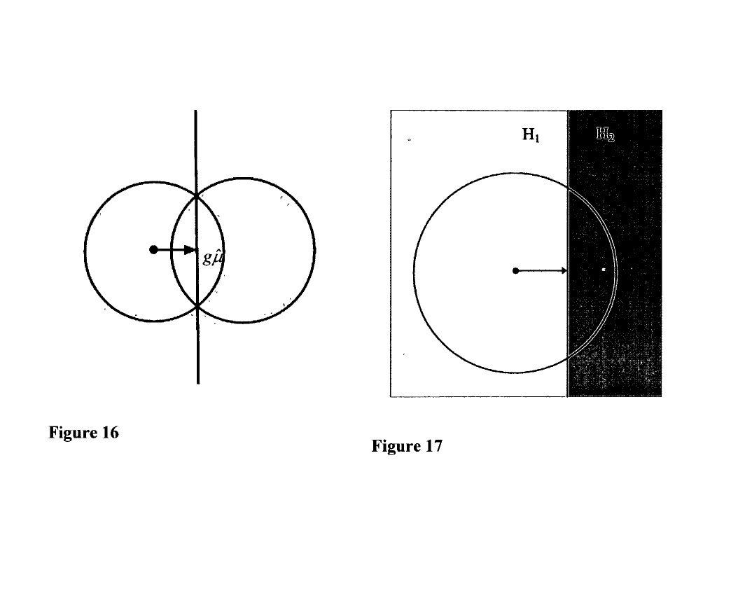

However, finding the atoms that intersect the central atom is not enough. There can be many spheres that intersect the central sphere that do not contribute to the exposed surface area and volume according to the decomposition described Sections 1.2 and 1.3. In the example in FIG. 14 and FIG. 15 neighbor B is occluded by the other two neighbors A and C and does not contribute to the area and volume calculation. Accordingly, there is a need to determine which connecting atoms to the central atom contribute to the exposed surface area and their connectivity.

2.3 Determining Which Intersecting Atoms to the Central Atom Limit its Exposed Surface Area and Their Connectivity

One embodiment according to the invention employs an Intersection of Half Spaces treatment to determine which neighbor atoms contribute to the exposed surface area of a particular central atom. The Intersection of N Half Spaces is a well-known problem in computational geometry and would be familiar to one skilled in the art. Preparata F. P., Shamos M. I., Computational Geometry, Springer Verlag, N.Y. (1985), Frankiewicz R., Braun W. J., Comp. Chem., 19, 319 (1998) One method for determining which intersecting atoms to the central atom limit its exposed surface area comprises the steps of: 1) determining a set of Half Spaces corresponding to the intersecting neighbors of the central atom; 2) determining the intersection of the set of Half Spaces; 3) determining the neighbors which limit the surface area of the central atom and their connectivity from the intersection of the IHS with the central atom.

2.3.1 Determining a Set of Half Spaces Corresponding to the Intersecting Neighbors of a Central Atom

Every neighboring atom that intersects a central atom may define an intersection plane that cuts through the two spheres, as shown in FIG. 16. As is shown in FIG. 17, this plane divides the space into two half-spaces, H₁ and H₂. The half-spaces may be formally described as follows: A plane in space that is at distance l from the origin may be defined by a vector \vec{p} that is normal to that plane and such that |\vec{p}|=l . All points \vec{r} in space that belong to this plane obey the plane equation:

\vec{r}·\vec{p}−|\vec{p}|²=0 (30)

The plane is the boundary between the two half-spaces it defines:

\vec{r}·\vec{p}−|\vec{p}|²<0 for \vec{r}∈H₁

\vec{r}·\vec{p}−|\vec{p}|²>0 for \vec{r}∈H₂ (31)

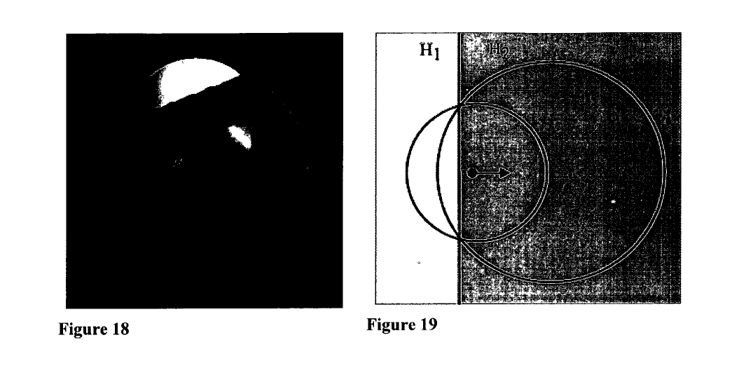

According to the vector parameterization defined in the section 1.4, the vector that defines the intersecting plane between atom i and neighbor k is gₖⁱ\hat{μ}ₖⁱ, where the unit vector \hat{μ}ₖⁱ points towards the center of the neighbor. For the case shown in FIG. 18 the solvent excluded volume and solvent accessible surface of the central atom are on the H₁ half-space that includes the origin, which may be defined as

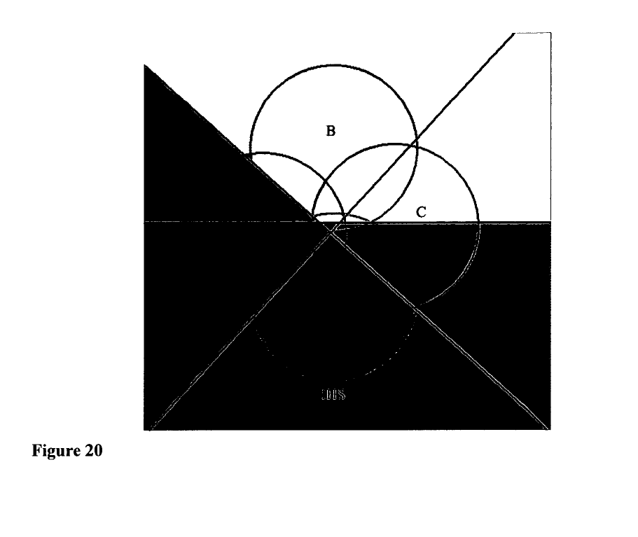

gₖⁱ\hat{μ}ₖⁱ·\vec{r}−(gₖⁱ)²≦0 (32)

where we also include the boundary. A slightly different case arises, and is shown in FIGS. 18-19 when the neighbor partially “swallows” the central atom. In such case, the intersecting plane is still defined by the vector gₖⁱ\hat{μ}ₖⁱ although now gₖⁱ is negative. The half-space H₁ that includes the excluded volume and accessible area is the one half-space that does not include the origin, thus

gₖⁱ\hat{μ}ₖⁱ·\vec{r}−(gₖⁱ)²≧0

or,

gₖⁱ\hat{μ}ₖⁱ·\vec{r}+(gₖⁱ)²≦0 (33)

In general, there can be both non-swallower and swallower neighbors. The solution to the set of equations (32) and (33) is the intersection of half-spaces (IHS) and it is the region of space that satisfies all the linear constraints imposed by the intersecting planes of all the neighbors. The IHS will be either an empty set or a convex set (infinite or finite) bounded by the planes that contribute to the exposed area and excluded volume. Thus, the faces of the convex polyhedron that bound the IHS belong to the intersection planes of the neighbors that truly intersect the central atom. See FIG. 20. By identifying the IHS we may identify neighbors that contribute to the surface area of the central atom. The IHS is an empty set if the constraints posed by the intersecting planes are inconsistent. This occurs if the central atom is completely swallowed by its neighbors. The exposed area and excluded volume for such case is zero.

The problem of determining the feasible points for a set of N linear constraints is well known in computational geometry and has attracted considerable attention. In the next section we present one suitable solution. As one skilled in the art will recognize, any solution to Equations 32 and 33 is sufficient.

2.3.2 Determining the Intersection of the Set of Half Spaces

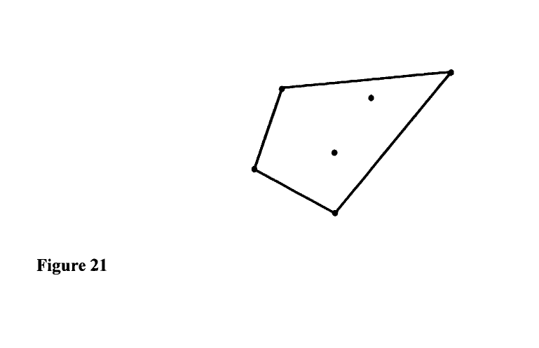

The convex hull (CH) of a set of points S in [symbol] ^{d} is the boundary of the smallest convex domain in [symbol] ^{d} containing S. See Preparata F. P., Shamos M. I., Computational Geometry, Springer Verlag, N.Y. (1985). We can intuitively think of the convex hull of a set of points in space as the geometric figure that would arise if we were to wrap the outside set of points with an elastic band. A two-dimensional example of a convex hull is shown in FIG. 21. The CH is defined by the “most outwards” points of the set of points.

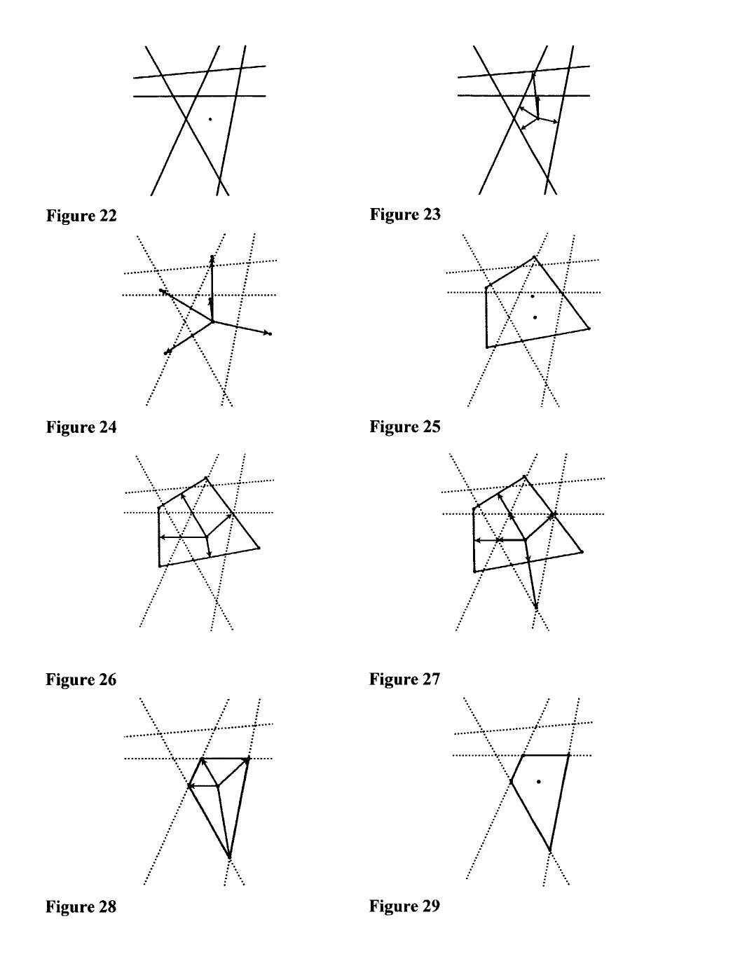

The crucial property of the IHS is that if we dualize the intersection planes, which define the IHS, to points, and construct the CH of that set of points, the dual of the CH is the IHS. In other words, the dual of the IHS is the CH of the dual of the constraints. Accordingly we have one recipe for computing the IHS: Each intersecting plane k of the central atom i is a linear constraint described by the vector gₖⁱ\hat{μ}ₖⁱ. The dual of each intersecting plane is the point \hat{μ}ₖⁱ/gₖⁱ. Then we calculate the convex hull of all the dual points, including the origin (which is the center of the atom i). For each face of the CH, we find its dual point. Using the topological equivalence between the CH and its dual, we connect the duals of the faces of the CH. The resulting polyhedron is the IHS. This procedure is shown schematically in FIGS. 21-29 for a two-dimensional example. Effectively this procedure is able to remove the occluded constraints because of the nature of the geometric inversion. This mapping brings points close to the center far away from it, and vice versa. The occluded constraints correspond to far-away points. By inverting them, we bring their duals close to the center and then the convex hull of the duals selects the ones farthest away from the center in the dual space (closest to the center in real space), thus removing the occluded constraints.

We include the center of the atoms in the set of points for which we construct the CH because it corresponds to a constraint at infinity. We call the center in the dual space the “zero point.” If the IHS is open, like a convex cone instead of a convex polyhedron, as in the example in FIG. 20 the center will be a vertex of the CH. After dualizing the CH, all faces that include the zero point are removed from the IHS polyhedron, thus creating the open IHS. These faces are called “zero” faces.

A key property for this procedure is the existence of the coordinate center inside the IHS. In order to dualize the intersection planes, we must have a point with respect to which we do the geometric inversion. This point was taken as the center of the atom, because it is usually inside the IHS. However, if at least one of the neighbors is a swallower, the center of the atom is no longer in the IHS, as shown in FIG. 18. Thus, before we can apply the aforementioned procedure, we need to find an interior point of the IHS. This is a non-trivial issue since we are seeking for a point inside a region for which we do not yet know its boundaries, and finding these boundaries is the actual problem we have to solve and we need the interior point for. We can find though a vertex of the IHS, without knowing anything else but the constraints, by using linear programming.

An additional complication that arises when there are swallower neighbors is the existence of both a common interior (the IHS) as well as a common exterior, the region of space for which the constraints (Equations 32-33) are inverted (if the constraints are not inconsistent). As described above, the duals of the faces of the CH correspond to vertices of the common interior (IHS). In the presence of swallowers, however, the duals of certain faces of the CH correspond to vertices of the common exterior. These faces have to be identified and removed from the CH in order to build the HIS correctly. The procedure then is slightly modified as follows: The zero point is not included in the construction of the CH. After the CH is calculated, we identify which faces of it are visible from the zero point. The duals of those faces are vertices of the common exterior. We name these faces “negative” faces because if we reformulate the problem using homogeneous coordinates in four dimensions, then these vertices are points of the hyperplane x₄=−1, whereas the three-dimensional space we are working on is the hyperplane x₄=1. Negative faces actually correspond to constraints at infinity, much like the zero point corresponds to a constraint at infinity, thus creating an open IHS.

2.3.3 Determining the Connectivity of Those Intersecting Atoms to the Central Atom Which Limit the Exposed Surface Area of the Central Atom

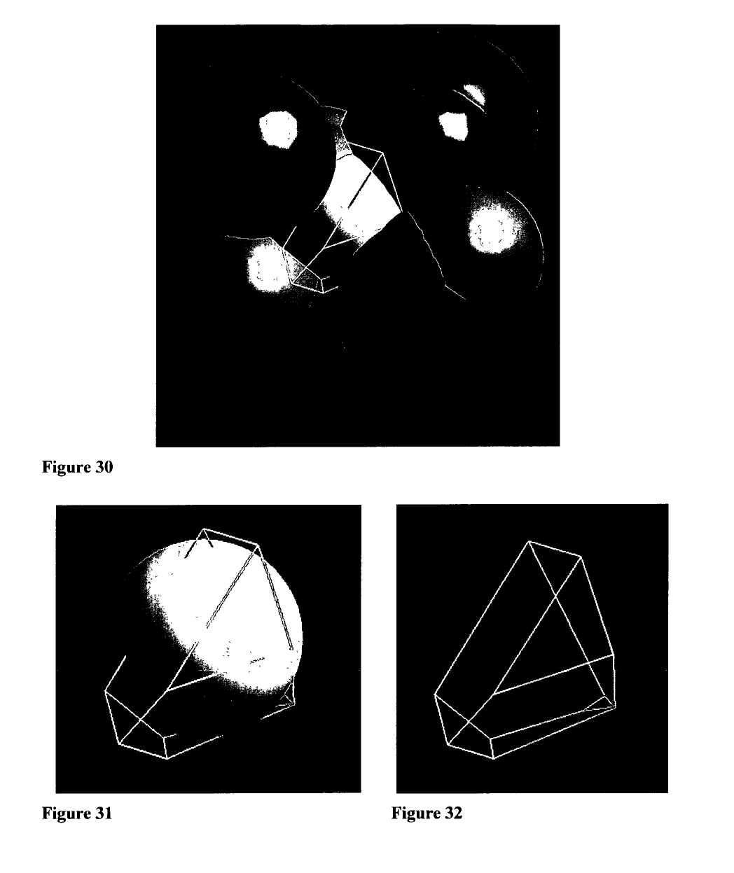

The steps described in sections 2-2.3.2 allow us to determine which intersecting neighbors contribute to the IHS. The next task is to identify which neighbors form GB-arcs on the surface of the central atom and the exact topology of these neighbors on the surface of the atom. If the COIs of these neighbors are intersecting each other then they intersect at the GB-points (see FIG. 11 and vectors \vec{P}ₖⱼⁱ, \vec{Q}ₖₗⁱ in FIG. 12). Each such neighbor contributes at least one GB-arc (except in the trivial case of an isolated neighbor, as in FIG. 3) and two neighbors that intersect each other may contribute at most two GB-points. Each GB-arc is a section of the COI of a particular neighbor, bounded by two GB-points at the beginning and the end. The orientation of the GB-arcs is CCW, looking from top, according to the convention we set in Section 1.4. The goal then is to identify which neighbors° COIs intersect each other thus forming a GB-point, group the GB-points into subsets that belong to each GB-path and then order the GB-points of each group as they form the GB-path in a CCW fashion. When the GB-paths have been determined we can use equation 18 to calculate the exposed area and equations 13-14 for the excluded volume. We have recognized that a convenient property to allow us to solve this problem is the fact that the edges of the IHS pierce the surface atom at exactly the GB points. FIG. 30, FIG. 31 and FIG. 32 illustrate for the case of the IHS polyhedron for the central atom shown in FIG. 1.

Each face of the IHS is a polygon-shaped section of the planar boundary of the half-space imposed by the corresponding neighbor. The COI of that neighbor lies on the plane of the face. If the whole COI lies inside the face, as is shown in FIG. 3, the neighbor is isolated. If the whole COI lies outside the face (but on the boundary plane) then the neighbor does not contribute any GB-arcs. If the COI lies partially inside and outside the face, as is shown in FIG. 12, then each point on the COI that is on an edge of the IHS is a GB point. An edge of the IHS is common to two of its faces. If an edge pierces the central atom, then the COIs of the corresponding atoms intersect at the GB points. In the case that all the vertices of the IHS are completely buried inside the atom, no edges intersect the surface of the atom and thus there are no GB-points. In such case, the atom has no exposed surface because it is buried under all its neighbors. However, the volume is not zero and it is the volume of the IHS.

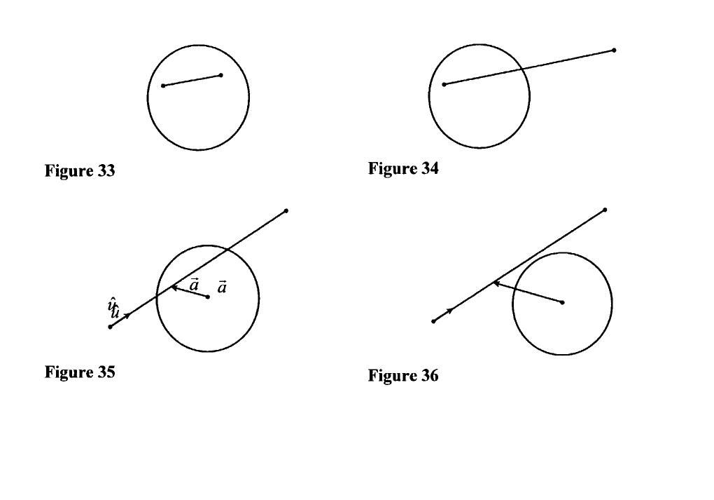

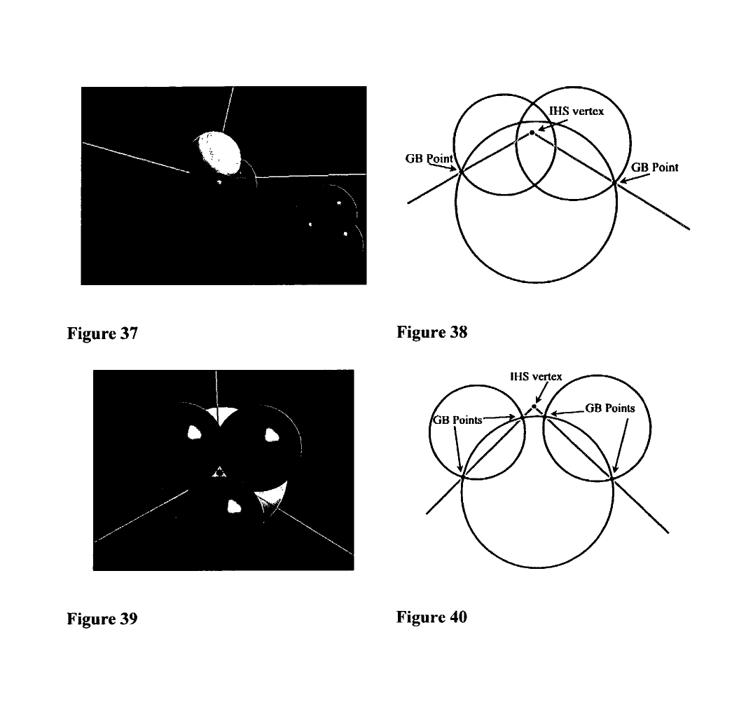

The edges of the IHS pierce the central atom zero, one or two times. This depends on the location of the vertices of the IHS that define the edges, with respect to the surface of the central atom. If both vertices are buried inside the atom then the edge does not intersect the surface of the central atom. If both vertices are exposed the edge can intersect in two points or none at all. This will have to be determined explicitly by the following sphere-line intersection test: If a line goes through a point \vec{r}ₒ and is parallel to the direction û then every point on the line obeys the line equation \vec{r}=\vec{r}ₒ+λû, for any real value of λ. The unit vector û is determined by the positions of the two vertices. All points on a sphere of radius R, centered at point \vec{r}_{c} obey the equation |\vec{r}-\vec{r}_{c}|=R. The system of the two equations has a solution if the quantity Δ/4=(\vec{a}û)²-(|\vec{a}|²-R²) is positive, where \vec{a}=\vec{r}ₒ−\vec{r}_{c}. Finally, if one vertex of the edge is buried and the other exposed, as is shown in FIG. 33-36, then the edge pierces the atom at exactly one point. The vertices of the IHS can give us even more information. By the very nature of the IHS, a vertex of it is the point in space where three boundary planes meet. If a vertex is buried then the three neighbors that correspond to each plane are connected on the surface of the atom. The three edges that emerge from that vertex will necessarily pierce the central atom once each, creating three GB-points. See FIGS. 37-38. If the vertex is exposed then the neighbors are not connected and the edges pierce twice, creating six GB-points. See FIGS. 39-40. We refer to these edges throughout as “double piercers.”

In the case of an open IHS, certain vertices are at infinity. These vertices are the duals of the zero faces of the CH in the case that there are no swallowers. If there are swallowers there are no zero faces since we do not include the center, but there are negative faces. The duals of those faces are taken to be at infinity, in order to create the true IHS, and clearly, they are exposed vertices (outside the central atom). The edges that have such vertices will fall either in the exposed-exposed or exposed-buried category, depending on the properties of the other vertex. The analysis for these cases is the same as before, with the exception that the direction vector û of the edge (for the intersection check) is taken towards the open face of the IHS, which in the case of a negative face is opposite to the dual of the face.

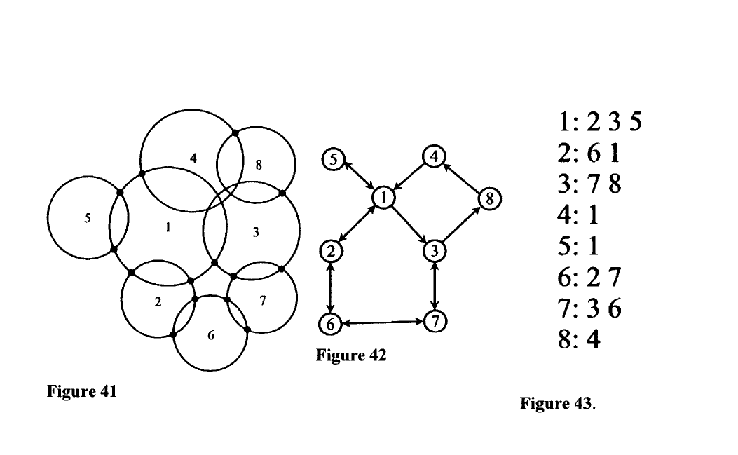

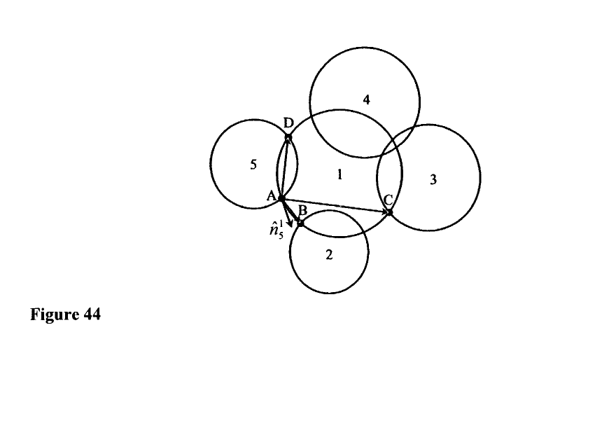

Using the above ideas, we can generate the list of GB-points that are on the surface of the central atom. After the IHS is constructed, we loop over each edge and analyze its vertices to recognize how many GB-points it creates. Each edge is connecting two neighbors. The GB-points are then assigned to one of the two neighbors, according to the CCW orientation that we have chosen in section 1.5. For example, in FIG. 12, the GB-point \vec{P}ₖⱼⁱ would be assigned to neighbor j and the GB-point \vec{Q}ₖₗⁱ to neighbor k. This way we create a list of connectivities between the true neighbors on the surface of the atom. The connectivity list is an oriented graph, where each oriented edge is a GB-point and each node is a neighbor. In the example of FIG. 41, the COIs of the neighbors on the surface of an atom are shown unfolded onto a plane. The resulting connectivity graph and connectivity table of the GB-points is shown in FIGS. 42-43.

It is possible that the connectivity graph can have more than one connected component. Each connected component corresponds to a disconnected piece of the buried surface of the atom, for which the Euler-Poincare characteristic is 2-n where n is the number of GB-paths on that piece, as was explained in section 1.4. In order to identify the connected components of the connectivity graph, we use the Depth-First-Search (DFS) algorithm, a recursive graph-searching algorithm. See Kozen D. C., The Design and Analysis of Algorithms, Springer Verlag (1992). After finding the connected components, we divide the graph to the respective sub-graphs. We then need to sort the vertices of each sub-graph, thus ordering the GB-points as they form the GB-paths. The GB-paths correspond to cycles of the connectivity graph. In the example of FIG. 41 there are two GB-paths. However, the related connectivity graph of FIG. 42 has more than two cycles. The reason for this inconsistency is that as we traverse the graph, there can be more than one option to select the next node, as shown in FIG. 44.

In this example, we start traversing the connectivity graph from node 5, so the next node can only be node 1. However, from that node we have three possibilities for the next step, nodes 2, 3 and 5, as is shown in FIG. 42 and FIG. 44 because there are 3 GB-points on the COI of neighbor 1. To pick the right one, we use the parameterization shown in FIG. 12. The tangent vector on the COI \hat{n}ⱼ^{ik}, at the GB-point \vec{P}ₖⱼⁱ from neighbors j-k , points to the direction of the GB-arc for that GB-point. The next GB-point has to be the end point of that GB-arc and thus the first point we encounter as we traverse the COI in a CCW fashion. Hence, the next GB-point has to be the “left-most” point relative to the direction \hat{n}ⱼ^{ik}, which is easily determined by the dot product of the direction vector to the vector that connects the current GB-point to the candidate next GB-points, as is shown in FIG. 44.

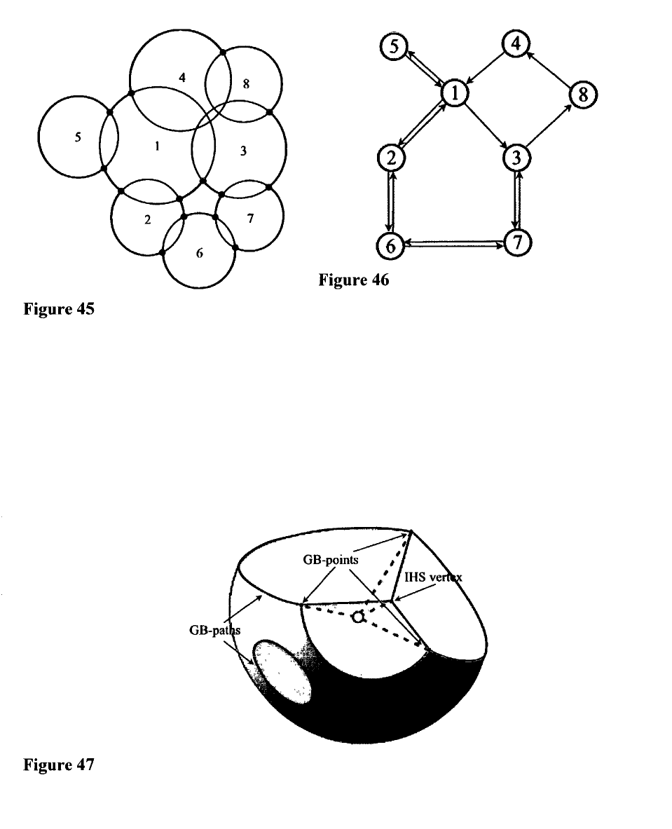

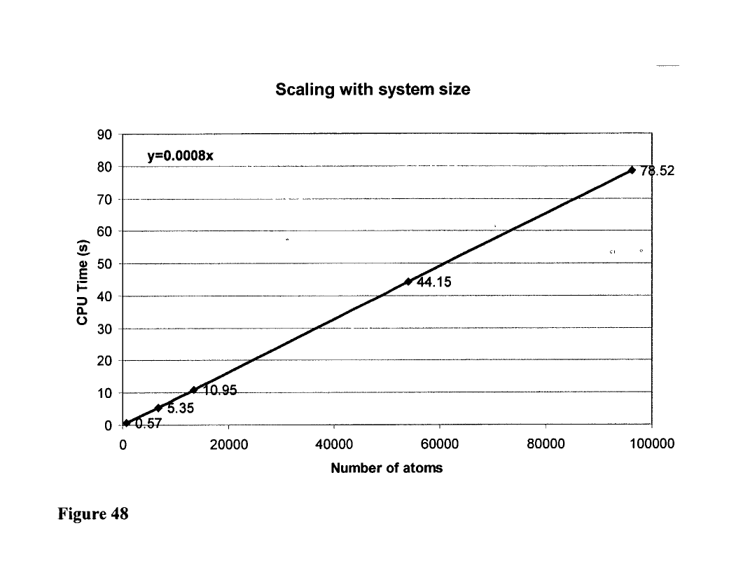

The determination of the cycles (the GB-paths), for each connected component of the connectivity graph, proceeds as follows: we pick a node in random, and pick an edge for that node in random. This node is the head of the current GB-path. The next node is chosen according to the “left-most” criterion described above. When the next node to be chosen is the head, we form a cycle, which is the GB-path. If there are oriented edges in the graph that have not been traversed, we pick one in random and continue this procedure until all edges have been traversed. When we have finished this analysis for all connected components, we have determined all the GB-paths for that atom. (See FIG. 45 and FIG. 46 for the GB-paths and cycles of the example of FIG. 41.)

With the topology of the true neighbors on the surface of the central atom determined, the exposed surface area calculations required for section 1.4 may be determined automatically for any solute topology. Also, the knowledge of the IHS and the GB-paths allow us to understand better how the planar sections of the building blocks are formed, as shown in FIG. 47. The planar sections are bounded by arc-segments and line segments, as was illustrated in FIG. 10. The arc-segments are the GB-arcs and the line-segments are parts of the edges of the IHS. The vertices of the line-segments are either buried vertices of the IHS or GB-points. The identification of these vertices is necessary for the calculation of the volumes using equations (13) and (14). In particular, the knowledge of which neighbors intersect to create the buried IHS vertices of the GB-points is needed for the calculation of the length of the line-segments, t_{μ}, in equation 14 The calculation of the IHS and its analysis, as explained above, provides this topological information.

### 3. Methods for Determining Solvation Energies

The methods detailed in Section 2 and 3, allow us to efficiently calculate the solvent accessible surface area Aᵢ and solvent excluded volume Vᵢ, with their gradients, for every atom i in a molecular system, assuming a fused-sphere representation for the system where each atom is represented by a sphere of radius rᵢ+rₚ, where rᵢ is the van der Waals radius of atom i and rₚ the probe radius of the solvent, as it “rolls” around the solute. The volumes of each atom are necessary for the calculation of polar solvation effects according to the continuum dielectric theory, in the Generalized Born approximation, as was described in the Introduction. In particular, under certain approximations, the Born radii are calculated by equations (6) and (10) for which the solvent excluded volumes Vᵢ of each atom i are needed. Since these volumes are calculated analytically, we referred to this version of Generalized Born the “Analytical Volume Generalized Born” (AVGB) method. At the same time, as was further explained in the Introduction, short range solvation effects are linearly dependent on the solvent accessible surface (SAS) areas of each atom in the system. The volume calculations have as a prerequisite the exposed area, so the short-range term is readily available in this calculation. The full salvation model includes both short-range and long-range (polar) effects and we call this the AVGB-SAS solvation model. In the following we will investigate the performance of the model as far as physical predictions and computational efficiency.

3.1 Implementation of Geometric Algorithms

The geometric algorithms presented in Sections 2-2.3.3. were implemented in a computer program in the C programming language, Kernighan B. W., Ritchi D. M., The C Programming Language, Prentice-Hall, N.J. (1988). It is important for the implementation to be robust and efficient in order for it to be used in large molecular systems of complicated topology. The finite precision arithmetic used in computers can cause round-off errors that may lead to erroneous results, produce numerical infinities or even cause the program to crash. This is because of the dualization procedure described in Section 2.3. If the distance of a plane from the center, g, is too small (the plane is very close to the center), then the dual point of that plane will be very far away from the center in the dual space, and vice versa. Also, if four atoms come very close to intersecting at the same point in space, some GB-arcs can be very close to zero length and this can cause very small faces of the CH and numerical instabilities for the gradient calculation (see: Wawak R. J., Gibson K. D., Scheraga H. A., J. Math. Chem., 15, 207 (1994) for an analysis of problematic atom topologies). The geometric predicate used to calculate the CH determines the visibility of a face from a point and can give wrong answers due to round-off errors in the aforementioned cases. If the construction of the CH fails, then the result of the calculation can produce unphysical results, like negative surface area or volume, or infinite gradients. In molecular dynamics where the atoms are propagated in space by infinitesimal distances at every step, it is inevitable that we will come across such cases in the course of a long simulation for a large system. It is crucial that we can deal with these problems effectively.

These numerical precision problems were already known in the computational geometry community. The calculation of geometric constructs such as, convex hulls, or Voronoi diagrams faces similar issues due to finite precision. The solutions proposed fall into two categories: perturbation schemes and arbitrary precision arithmetic techniques. In perturbation schemes, the results are checked for unphysical conditions and if errors are detected the spheres in the fused-sphere model are perturbed about their centers by a very small distance that overcomes the degeneracies and precision problems, Emiris I., Canny J., Proceedings 8^{th} Annual Computational Geometry, Berlin, Germany, 74 (1992); Eisenhaber F., Argos P., J. Comp. Chem., 14, 1272 (1993); Halperin D., Shelton C. R., Comp. Geom., 10, 273 (1998). Arbitrary precision techniques attempt to create geometric predicates that produce results of arbitrary precision on finite precision machines. These techniques are conceptually better but computationally inefficient. New adaptive methods, however, promise efficient calculations for the geometric predicates, Clarkson K. L., Proceedings 33^{rd} Annual IEEE Symposium on Foundations of Computer Science, 387 (1992); Shewchuk J. R., Discrete Comput. Geom., 18, 305 (1997) (Note: public domain software implementation is available at http://www.cs.cmu.edu/˜quake/robust.html). In this implementation we used an adaptive arbitrary precision software library for the calculation of the geometric predicates, which is in the public domain, Shewchuk J. R., Discrete Comput. Geom., 18, 305 (1997) (Note: public domain software implementation is available at http://www.cs.cmu.edu/˜quake/robust.html).

Finally, another topology that can produce numerical instability is coplanar (or almost coplanar) molecules, like benzene. The problems are similar in nature as described above but the solution is simpler: if the centers of the atoms are almost coplanar, instead of calculating the CH in three dimensions we project the center of every atom on a plane and solve the two-dimensional CH problem.

3.1.1 Scaling and Performance

For a molecular system of N atoms we have to perform N calculations for the area and volume of each atom. Each calculation in turn involves the calculation of the IHS and its analysis. The time for the calculation of the IHS depends on the number of neighbor atoms, M , that intersect each atom. The calculation of M half-spaces scales as O(M log M) Preparata F. P., Shamos M. I., Computational Geometry, Springer-Verlag, N.Y. (1985), thus the calculation of the whole system takes time O(NM log M). It is important then to determine if and how the number of neighbors M depends on the total size of the system, N Halperin D., Overmars M. H., Comp. Geom, 11, 83 (1998).

Let us define ^{r}ₘₐₓ and ^{r}ₘᵢₙ the maximum and minimum radius of any sphere in the system and k=rₘₐₓ/rₘᵢₙ their ratio. Also, if dₘᵢₙ is the minimum distance between any two atoms (physically corresponding to the minimum valence bond length), then we define the ratio λ=dₘᵢₙ/rₘₐₓ. Let M be the neighbors of any atom i, or radius rᵢ. Then, all M neighbors' spheres will be completely engulfed in a sphere centered at i with radius \vec{r}ᵢ+2rₘₐₓ. For each neighbor we define a sphere of radius λrₘᵢₙ/2. Then these spheres do not intersect each other because their centers are at a distance smaller than dₘᵢₙ:

$$2 ( \frac{λ}{2} {r}_{min} ) = λ {r}_{min} = \frac{{d}_{min}}{{r}_{max}} {r}_{min} = \frac{{d}_{min}}{κ} < {d}_{min} \qquad ( 34 )$$

since k>1. Hence, the sum of their volumes has to be less than the volume of the engulfing sphere:

$$M \frac{4}{3} π {( \frac{λ}{2} {r}_{min} )}^{3} \leq \frac{4}{3} {π ( {r}_{i} + 2 {r}_{max} )}^{3} \\ M \leq \frac{{( {r}_{i} + 2 {r}_{max} )}^{3}}{{( \frac{λ}{2} {r}_{min} )}^{3}} \leq \frac{{( 3 {r}_{max} )}^{3}}{{( \frac{λ}{2} {r}_{min} )}^{3}} \\ \text{Thus:} \\ M \leq {( 6 \frac{κ}{λ} )}^{3} \qquad ( 35 )$$

So, the number of neighbors M is bounded by a constant that depends on the radii and distances of the spheres of the fused-sphere model. In practice, for the parameters we used, we noticed that the maximum number of intersecting neighbors never exceeded 150, whereas the average value was around 80. Hence, as is illustrated in FIG. 48, the calculation of the areas and volumes scales linearly with the size of the system, O(N).

The algorithms presented were implemented in three different platforms: Linux (Intel), Irix (Silicon Graphics) and AIX (IBM) operating systems. The results are extremely accurate as compared to numerical calculations of the volumes of test molecules and very fast. On an Intel Pentium III 866 MHz the average time spent for the area and volume calculation of one atom is around 0.8 ms (FIG. 48). Areas of proteins of typical size, 2000-5000 atoms can be calculated analytically, with gradients, in seconds. To the best of our knowledge, this the fastest implementation of the analytical calculation of areas and volumes per atom for a fused-sphere model to date.

3.2 Validation of the AVGB Model

The AVGB model is an approximation to the solutions of the PB equation (3). In order to assess the quality of the AVGB model, we will compare our predictions to the results of numerical solutions of the PB equation. The best-known implementations are the DelPhi program, Gilson M. K., Honig B., Proteins, 4, 7 (1988), UHBD, Davis M. E., McCammon J. A., J. Comput. Chem., 10, 386 (1989), and PBF Cortis C. M., Friesner R. A., J. Comput. CHem., 18, 1591 (1997). We will also compare our results to the SGB version, Ghosh A., Rapp C. S., Friesner R. A., J. Phys. Chem B, 102, 10983 (1998) of the GB approximation since it is the only GB implementation that does not depend on fitting parameters, as AVGB does neither. The comparison will be performed over different sets of molecules: small organic molecules, amino acids, large proteins and dimers.

3.2.1 Small Molecules

The 376-molecule set for the comparisons is from reference, Wang J., Wang W., Huo S., Lee M., Kollman P., J. Phys. Chem. B., 105, 5055 (2001), and each molecule has at most 40 atoms. In order for the comparisons to be unbiased, we use the same parameters for each test molecule in all methods. The van der Waals radii are taken from the DREIDING forcefield parameter set, Mayo S. L., Olafson B. D., Goddard III W. A., J. Phys. Chem, 94, 8897 (1990). The charges are calculated from electrostatic potential (ESP) fitting, Cox S., Williams D., J. Comput. Chem, 2, 304 (1981) of the quantum-mechanical wave functions of each atom in the molecule, which in turn were estimated by Hartree-Fock ab-initio electronic structure calculations using the JAGUAR program, Ringnalda M., Langlois J. M., Greeley R., Mainz D., Wright J., Pollard W. T., Cao Y., Won Y., Miller G., Goddard III W. A., Friesner R. A., Schrodinger Inc. (1994) and the 6-31G** basis set. The probe radius of water is assumed be approximately 1.4Å, the hard-sphere radius of water in the liquid state Gogonea V., Baleanu C., Osawa E., J. Molec. Struct. (THEOCHEM), 432, 177 (1998). The dielectric constant of water is 78.2, and for the interior dielectric constant we chose a value of 1.

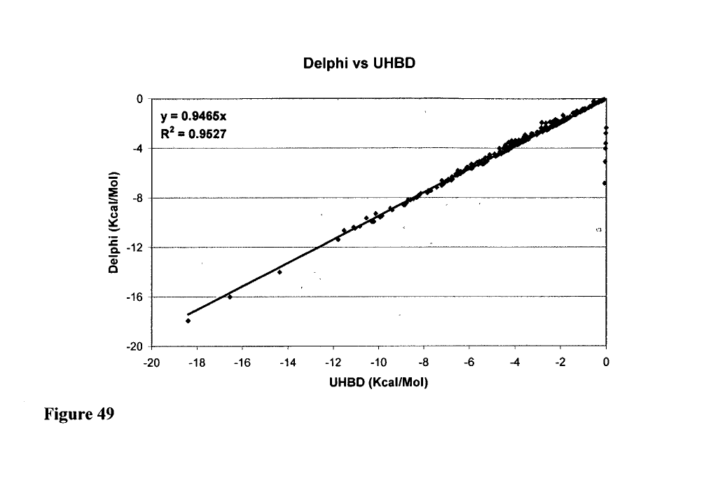

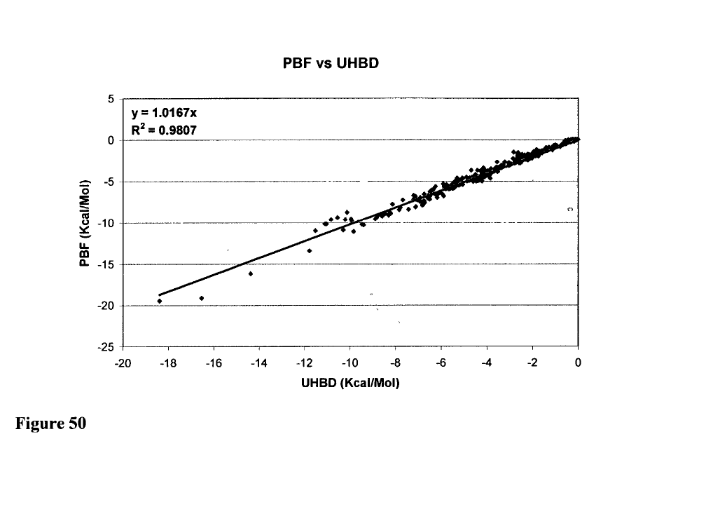

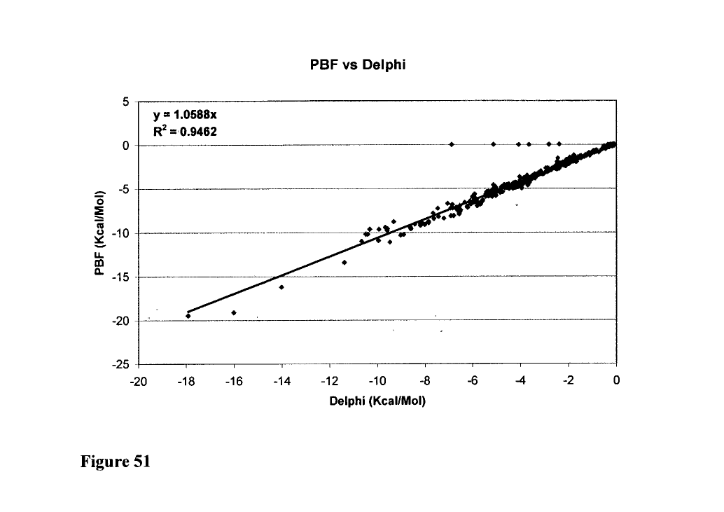

In FIGS. 49, 50 and 51 we compare the different methods that calculate numerically the PB equation, UHBD, Delphi and PBF. All methods correlate strongly with each other, as is shown by the linear regression coefficient R². The linear regression fit for every comparison is very close to the ideal y=x line. However, looking more closely we see that UHBD behaves better overall, as is shown by the RMS differences between the results of the different methods. Delphi produces erroneous results for a few molecules and PBF does not correlate as strongly as the other two methods with each other. Thus, for the rest of the comparisons we will focus on UHBD as the method of choice for comparing GB to PB results.

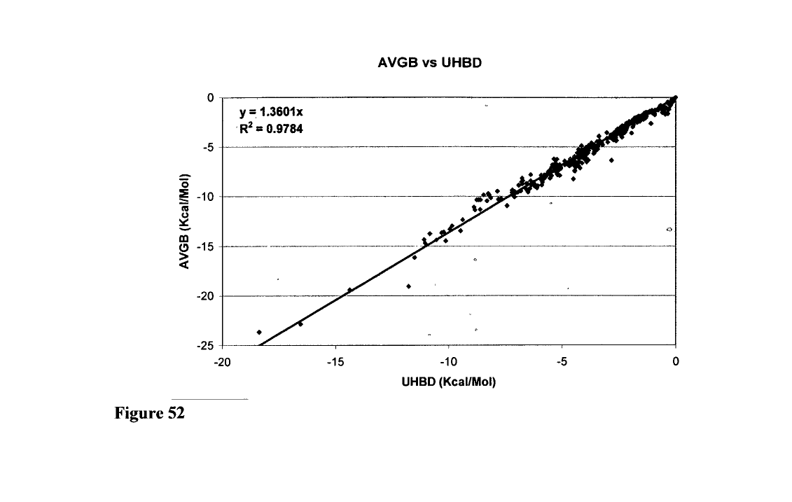

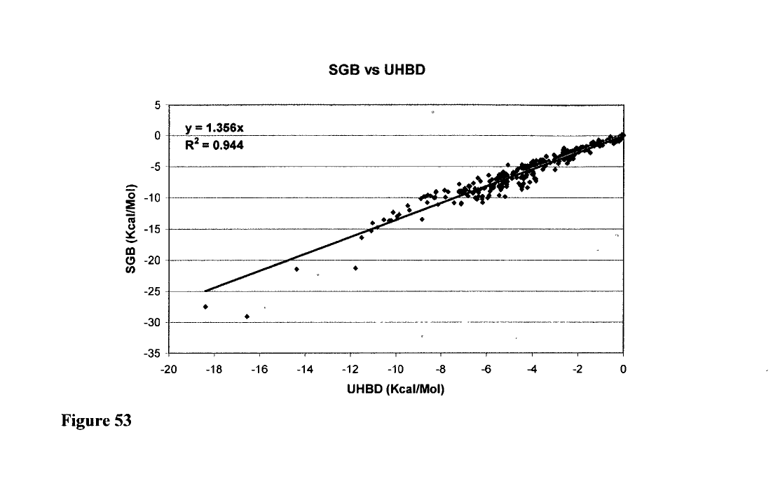

In FIG. 52 we compare the results between AVGB and UHBD and in FIG. 53 between SGB and UHBD. In both cases we see that the GB results are very well correlated to the PB numerical solutions, as shown by the linear regression coefficient, with AVGB correlating slightly better to the PB results than SGB does (R²=0.98 for AVGB and R²=0.94 for SGB). However, in both methods we observe a systematic deviation from the PB results, as is shown by the regression fits to the line. The slope a is different than unity and almost the same for both methods, 1.36, which means that both GB methods overestimate the polar solvation energy as the system gets more solvated. At the same time, the Coulombic approximation introduced in the Born radius calculation in equation (6), along with the pairwise approximation, equation (10), may lead to additional errors that result in the systematic deviation from the correct PB results. The fact that both GB methods have almost the same systematic error hints to the fact that the deviation is probably not due to the volume or area calculation or the approximations used for the calculation of equation (6). It is the interpolation formula and the coulombic approximation that leads to the formula for the calculation of the Born radii, equation (6), that are inducing the systematic error in the calculation of the polar solvation energies.

The fact that the error is systematic allows us to calibrate our parameters such that the predictions of AVGB very closely match the PB solutions. Accordingly, the success of such approach will depend on the number of parameters that need calibration, and the applicability of the calibrated results to molecular systems outside the set used for calibration. Since the deviation is systematic and linear in nature, we can take advantage of the dependence on the interior dielectric constant εᵢₙ to calibrate the AVGB results. In particular if U_{PB} is the PB polar solvation energy and U_{GB} the GB polar solvation energy, then, according to Figure it is U_{GB}=aU_{PB}. We can express as

$${U}_{GB} = ( \frac{1}{{ϵ}_{in}} - \frac{1}{{ϵ}_{out}} ) S \qquad ( 36 )$$

where

$$S = - \frac{1}{2} {\sum }_{i = 1}^{N} {\sum }_{j = 1}^{N} \frac{{q}_{i} {q}_{j}}{{f}_{ij}} .$$

We seek for a value εᵢₙ′ of the interior dielectric constant such that U_{GB}=U_{PB}. Then, we must have

$$( \frac{1}{{ϵ}_{in}^{′}} - \frac{1}{{ϵ}_{out}} ) = \frac{1}{a} ( \frac{1}{{ϵ}_{in}} - \frac{1}{{ϵ}_{out}} ) or , \\ \frac{1}{{ϵ}_{in}^{′}} = \frac{1}{{ϵ}_{out}} + \frac{1}{a} ( \frac{1}{{ϵ}_{in}} - \frac{1}{{ϵ}_{out}} ) \qquad ( 37 )$$

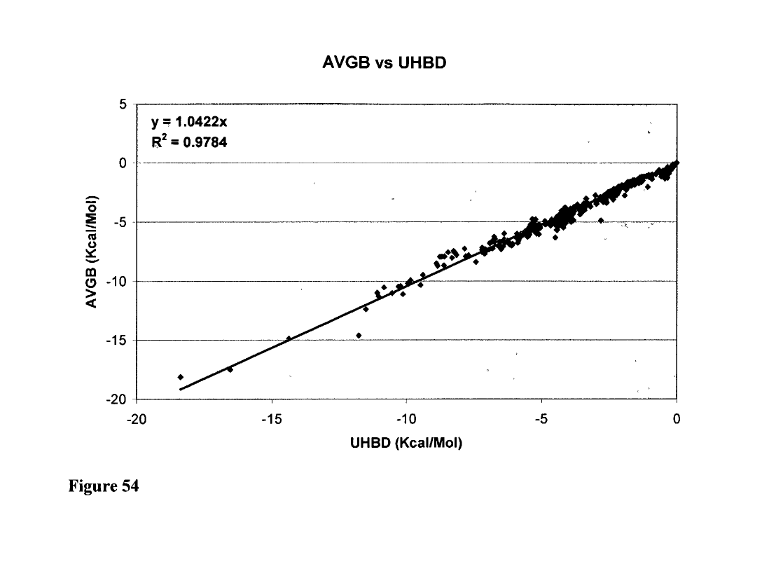

Using equation (37) we can predict the value εᵢₙ′ that would give results that are very close to the PB solutions. In our case, using a=1.36, εₒᵤₜ=78.2 and εᵢₙ=1.0, we get εᵢₙ′≈1.3. In FIG. 54 we compare the results of AVGB with εᵢₙ=1.3 to UHBD with εᵢₙ=1.0. The correlation coefficient R² =0.98 obviously is the same as in Figure, but the slope of the linear fit is now much closer to unity, a =1.04. The RMS difference between the two methods is 0.46 Kcal/Mol. The agreement of the AVGB results to the numerical solutions of the PB equation is excellent and the differences are not larger than the ones between the different implementations of numerical solutions of the PB equation, as shown in FIGS. 49-51.

3.2.2 Large Molecules

We compared the polar solvation energies for 11 proteins, shown in Table 1. The radii used were from the DREIDING forcefield, Mayo S. L., Olafson B. D., Goddard III W. A., J. Phys. Chem, 94, 8897 (1990), charges from the CHARMM22 forcefield, MacKerell, A. D. et al., J. Phys. Chem. B., 102, 3586 (1998) and the protein structures from the PDB protein databank. The solvent dielectric constant was taken εₒᵤₜ=78.2 for water and we tested AVGB with εᵢₙ=1.0 and εᵢₙ=1.3, and compared to UHBD with εᵢₙ=1.0. The solvent probe radius was 1.4Å.

TABLE 1
AVGB and UHBD polar solvation energies for 11 proteins.

| | Size | AVGB εᵢₙ = 1 | AVGB εᵢₙ = 1.3 | UHBD |
|---|---|---|---|---|
| Protein (nickname) | (Atoms) | (Kcal/Mol) | (Kcal/Mol) | (Kcal/Mol) |
| L-Arabinose (ara) | 4671 | −4478.08 | −3458.34 | −3236.64 |
| Carbonic Anhydrase II (cah) | 4032 | −3613.93 | −2790.97 | −2557.5 |
| Carboxypeptidase A (car) | 4791 | −3985.97 | −3078.29 | −2665.98 |
| Cytochrome P-450cam (cyt) | 6444 | −7922.67 | −6118.53 | −6354.81 |
| Intestinal FABP (fab) | 2112 | −2091.36 | −1615.12 | −1549.72 |
| Neuraminidase (nad) | 5978 | −5329.57 | −4115.93 | −3686.73 |
| Penicillopepsin (pep) | 4550 | −7003.04 | −5408.32 | −6061.3 |
| ε-Thrombin (ret) | 4766 | −5407.50 | −4176.11 | −4106.13 |
| Ribonuclease T1 (rib) | 1462 | −2191.02 | −1692.08 | −1790.5 |
| Thermolysin (tmn) | 4700 | −5150.37 | −3977.54 | −3835.41 |
| Trypsin (trp) | 3231 | −2929.91 | −2262.71 | −2086.56 |

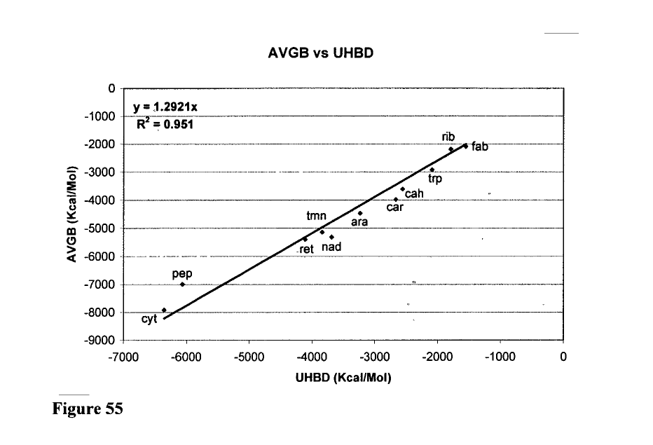

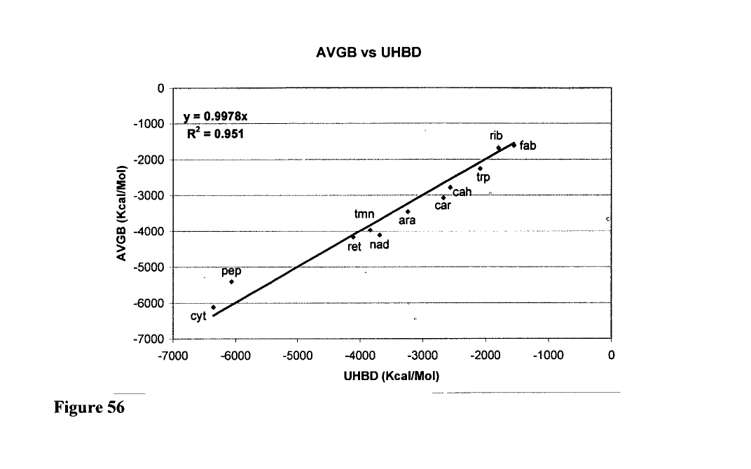

In FIG. 55 we see how AVGB compares to the numerical PB solution for the 11 proteins when we use the same value for the interior dielectric, εᵢₙ=1.0. We see that the two methods correlate very well to each other, R²=0.95, but as with the small molecules, there is a systematic error since the slope of the linear fit is 1.29. In FIG. 56 we compare AVGB with the calibrated value of the interior dielectric, εᵢₙ=1.3. The AVGB predictions are very close to the PB results as shown by the linear fit slope 0.998. The RMS difference is 303 Kcal/Mol, which is about 10% of the polar salvation energy of these systems. The differences between AVGB and UHBD are on the same order as between UHBD and Delphi, which are different implementations of the numerical solution of the PB equation.

The fact that the calibrated value of the interior dielectric that we obtained from the small molecule set works so well with these large systems implies that we can use εᵢₙ=1.3 for many molecular systems in order to get the polar solvation energy of that system, as predicted by the PB equation with εᵢₙ=1.0. Obviously, if we want the polar solvation energy for εᵢₙ≠1.0 we need to redo the calibration procedure explained in section 3.1.1. From this analysis it is clear that the calibrated AVGB results are guaranteed to predict the polar solvation energy for molecules of any size and any solvent and solute dielectric constants.

3.2.3 Intermolecular Polar Solvation Energies

In sections 3.1.1 and 3.1.2 we showed that AVGB can successfully reproduce the polar solvation energies for small and large molecules. For the method to be applicable more broadly, it should also be able to describe accurately complexes and multi-molecular systems. This problem is more difficult than a single molecule calculation because of the complexity of the geometry of the solute-solvent boundary and the screened intermolecular interactions that have to be accounted for. To test the behavior of AVGB in such cases, we examined the polar solvation energy of a THF dimer in different orientations, as a function of the distance between the two molecules. Qualitatively, we expect that the energy of the dimer at infinite distance should be equal to the sum of the individual molecules' energies. At very close distances, the polar solvation energy should increase as the distance decreases; otherwise salvation would favor the collapse of the dimer. At intermediate distances we expect to have a minimum for which the configuration is optimally favorable.

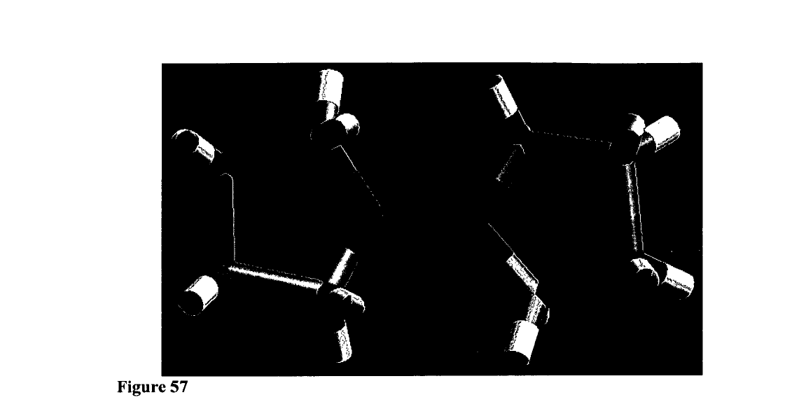

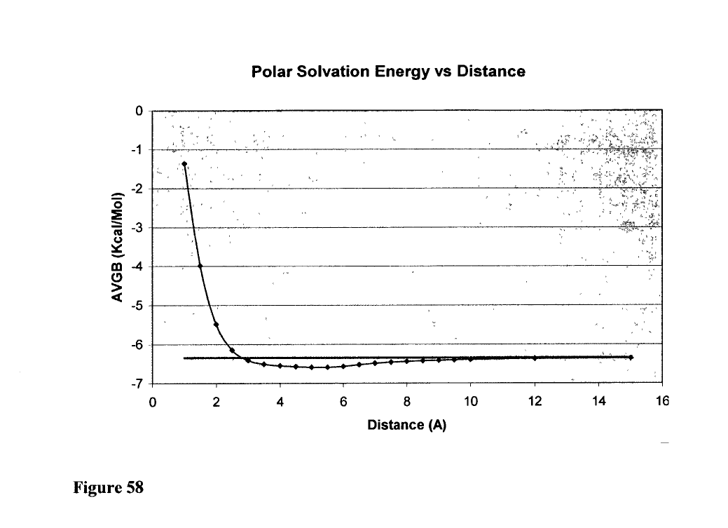

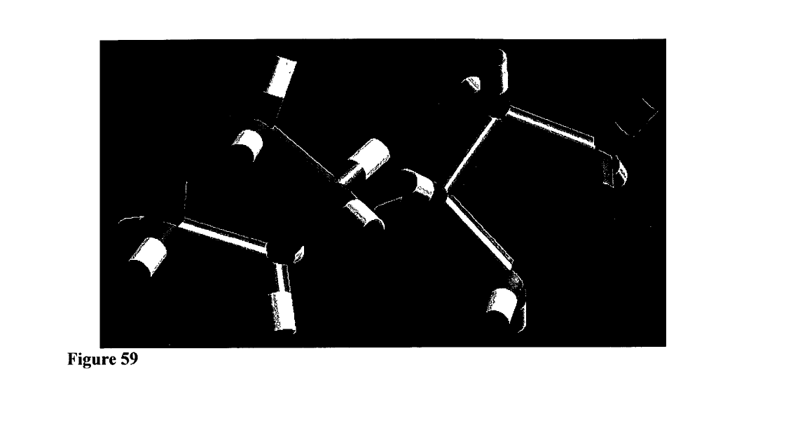

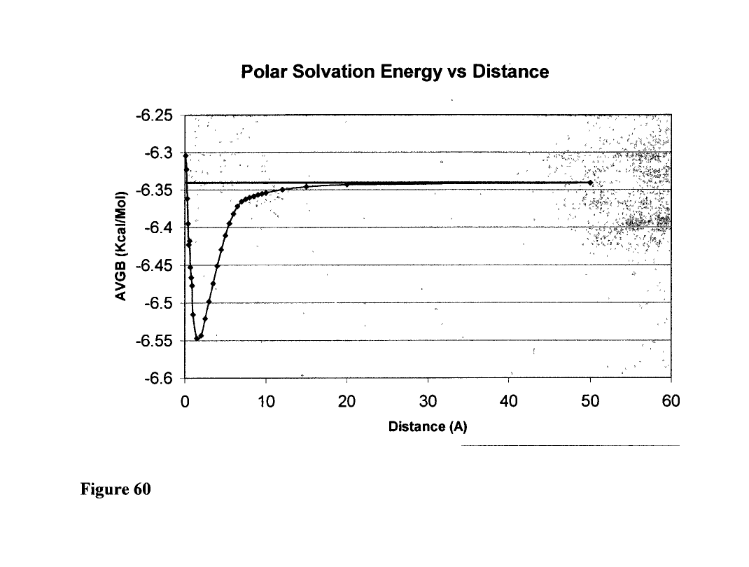

In FIG. 58 we see the polar solvation energy for the THF dimer of FIG. 57, where the polar oxygen atoms face each other. The salvation energy correctly reproduces the infinity and zero distance limits, and it is a smooth function of the intermolecular distance. Similarly, in FIG. 60 the polar solvation energy of the THF dimmer of FIG. 59 obeys similar behavior. In this case, the polar atoms are away from each other. AVGB is able to correctly reproduce the intermolecular polar solvation energy. We note that for the same test cases, all other methods (UHBD, Delphi, PBF and SGB) did not predict the correct energies at the infinity limits and the polar salvation energy was not a smooth function of the distance. It is not clear why these methods fail to calculate the polar salvation energy correctly for the intermolecular problem, although they can calculate the energies correctly for individual molecules. Since the main difference between AVGB and all other methods is the analytical calculation of the geometry of the molecules, we believe that the numerical calculation of the boundaries of the molecules in multi-molecular systems used is wrong for such cases in these methods. At the same time, it is possible that since dimers with large intermolecular distances were examined, a much higher grid resolution would be needed to solve accurately the PB equation, but that would make the calculation practically infeasible.

3.3 The Short-Range Term

In section 3.1 we showed that the AVGB model for the calculation of the polar solvation energy and forces gives superior results, as compared to numerical solutions of the PB equation. In order for our model to incorporate all salvation effects, as explained in the Introduction, we must have a term that accounts for short-range effects such as van der Waals and entropic effects. We showed that such effects can be described by a term that is linear dependent on the solvent accessible surface area Aᵢ of every atom i in an N-atom system:

$$Δ {G}_{vdW} + Δ {G}_{cav} = {\sum }_{i}^{N} {σ}_{i} {A}_{i} \qquad ( 38 )$$

The parameters σᵢ have units of surface tension, Energy/Area, and in general could be different for every atom in the system.

In order to determine the surface tension parameters for water, according to the AVGB-SAS model, we subtract the polar energies as predicted from AVGB from the experimental salvation energies of a large set of molecules, to get the predicted short-range contribution to the solvation energies. We then fit the surface tensions for each atom so that the differences in the energy predicted from equation (38) compared to the short-range term, for each molecule, are minimal. Clearly, the surface tensions that we get from this procedure depend on the molecule set and the parameters used in the AVGB calculation. It is important then to have experimental solvation free energies for a large set of molecules with diverse chemical groups. We use a set of 376 organic compounds for which the experimental solvation energies in water are given in: Wang J., Wang W., Huo S., Lee M., Kollman P., J. Phys. Chem B., 105, 5055 (2001) and the references therein.

The parameters for AVGB are the atomic radii, the probe radius of the solvent, the charges of the atom, and the three-dimensional structure of each molecule. For the atomic radii we used the values from reference, Tannor J. D., Marten B., Murphy R., Frisner R. A., Sitkoff D., Nicholls A., Ringnalda M., Goddard III W. A., Honig B., J. Am. Chem. Soc., 116, 11875 (1994), which were optimized to reproduce water solvation energies of a small number of organic compounds by means of Hartree-Fock and Poisson-Bolzman calculations. The probe radius of water was taken to be 1.4Å, according to Gogonea V., Baleanu C., Osawa E., J. Molec. Strut. (THEOCHEM), 432, 177 (1998), and the charges were derived from quantum-mechanical calculations described in section 3.1.1. The three-dimensional structures of the molecules were derived from energy minimization using the DREIDING forcefield, Mayo S. L., Olafson B. D., Goddard III W. A., J. Phys. Chem, 94, 8897 (1990). Finally, the solute dielectric constant was 78.2 and for the interior we used the calibrated value of 1.3, according to section 3.1.1.

Initially we attempted to reproduce the experimental water solvation energies for our molecule list by using solvation types that depend only on the element of each atom. With the above-mentioned parameters the linear optimization procedure gave the surface tensions shown in Table 2 for each element represented in the molecule list.

TABLE 2
Surface tensions for water in (Kcal/Mol Å²)
per element, for the AVGB-SAS solvation model.

| | Surface Tension |
|---|---|
| Element | (Kcal/MolÅ²) |
| H | 0.0007 |
| C | 0.0107 |
| O | 0.0094 |
| N | −0.0448 |
| F | 0.0149 |
| S | −0.0076 |
| Cl | 0.0003 |
| Br | −0.0009 |
| I | 0.0021 |
| P | 0.5047 |

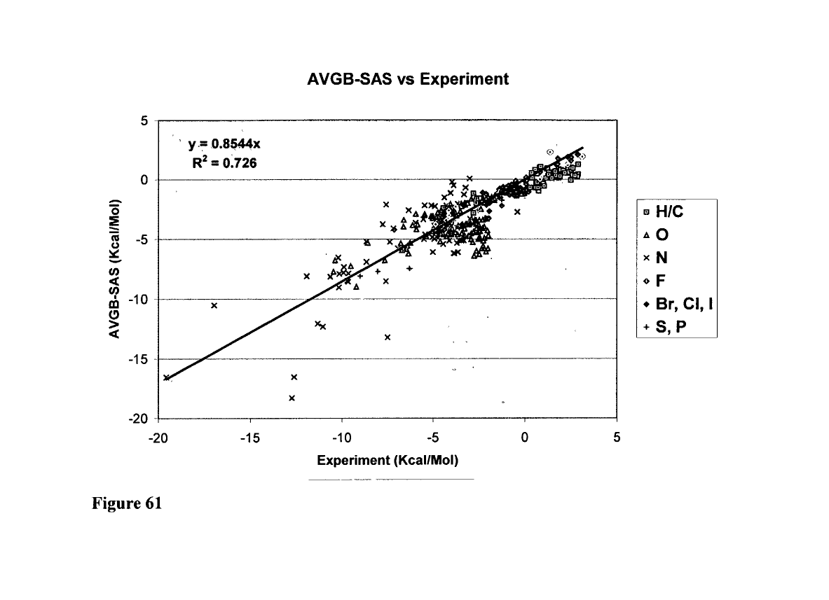

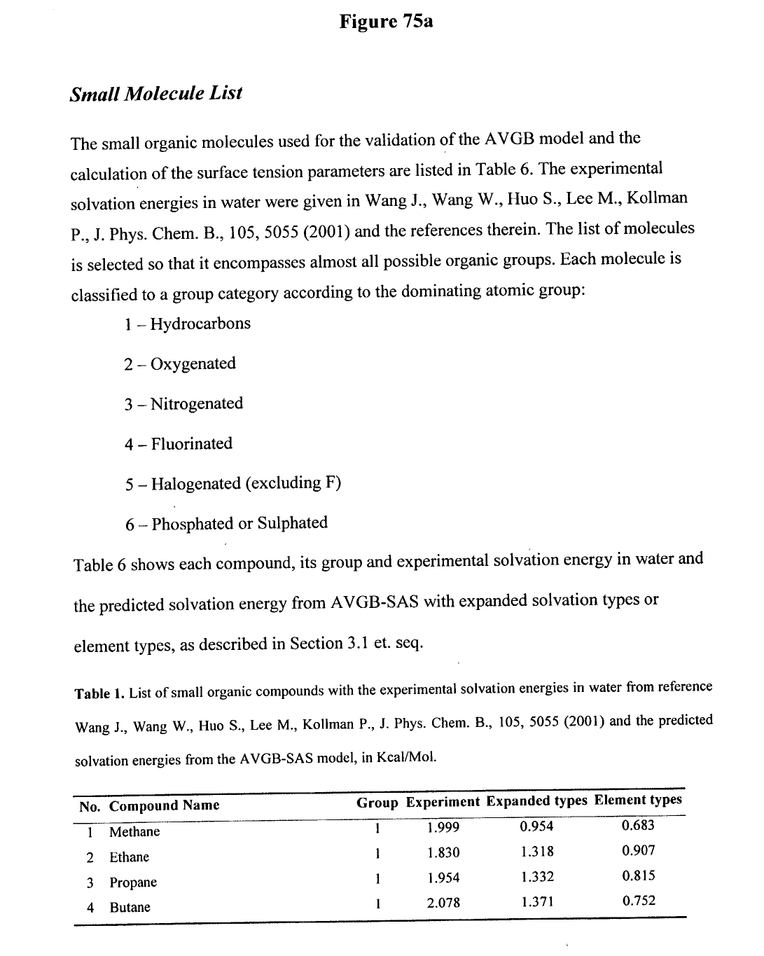

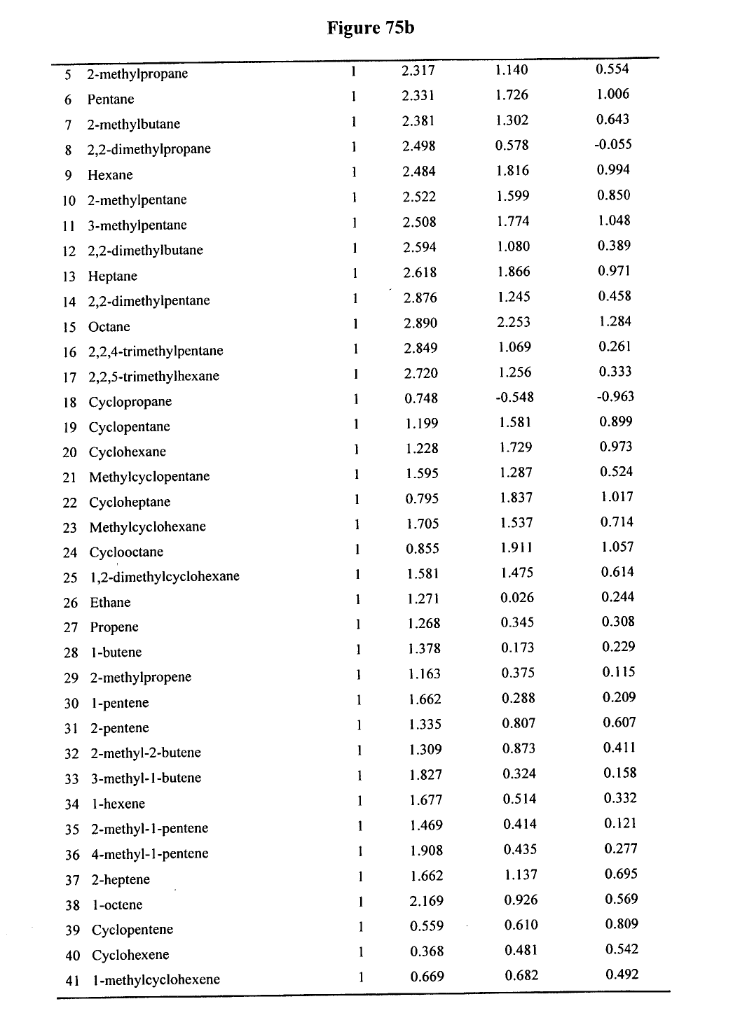

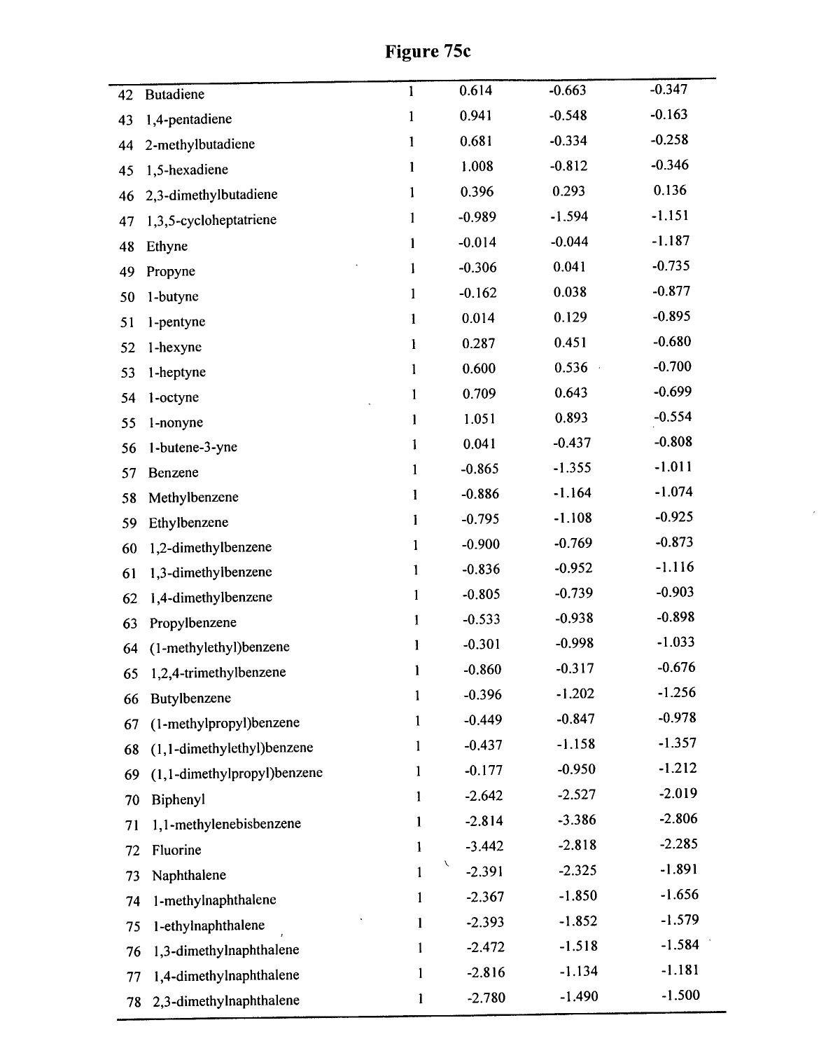

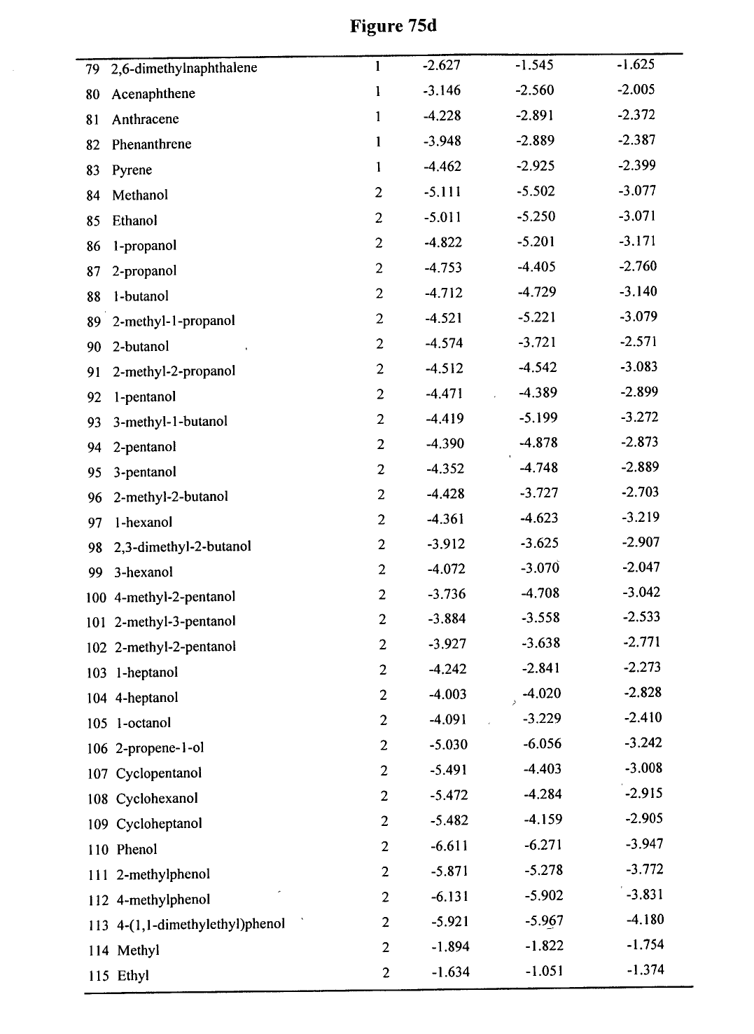

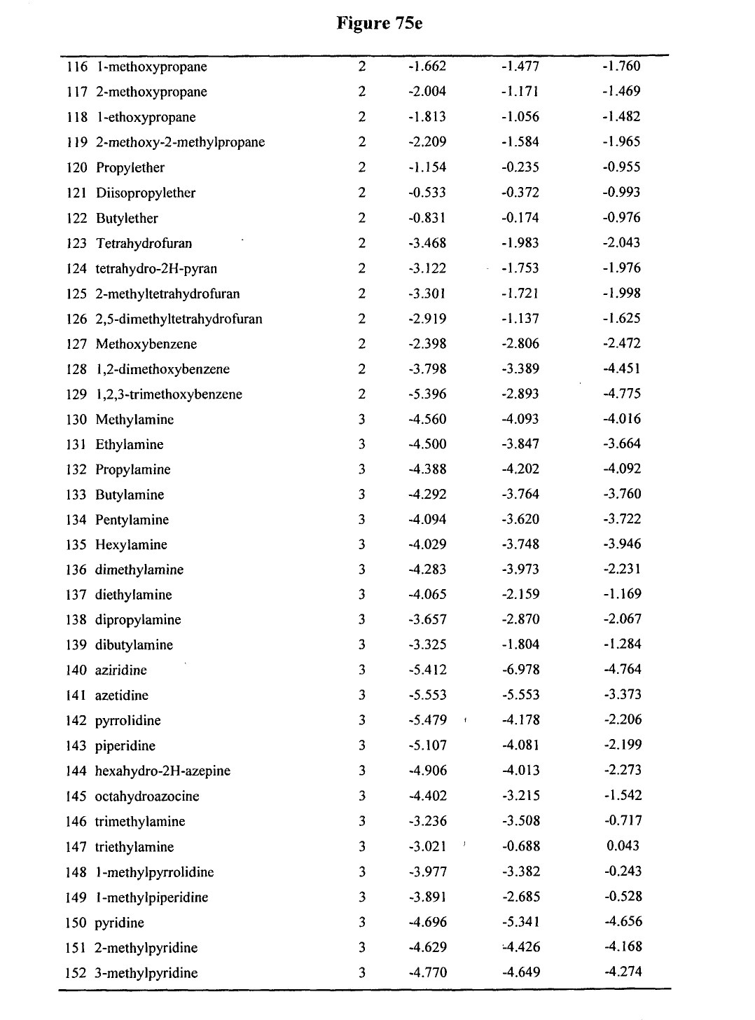

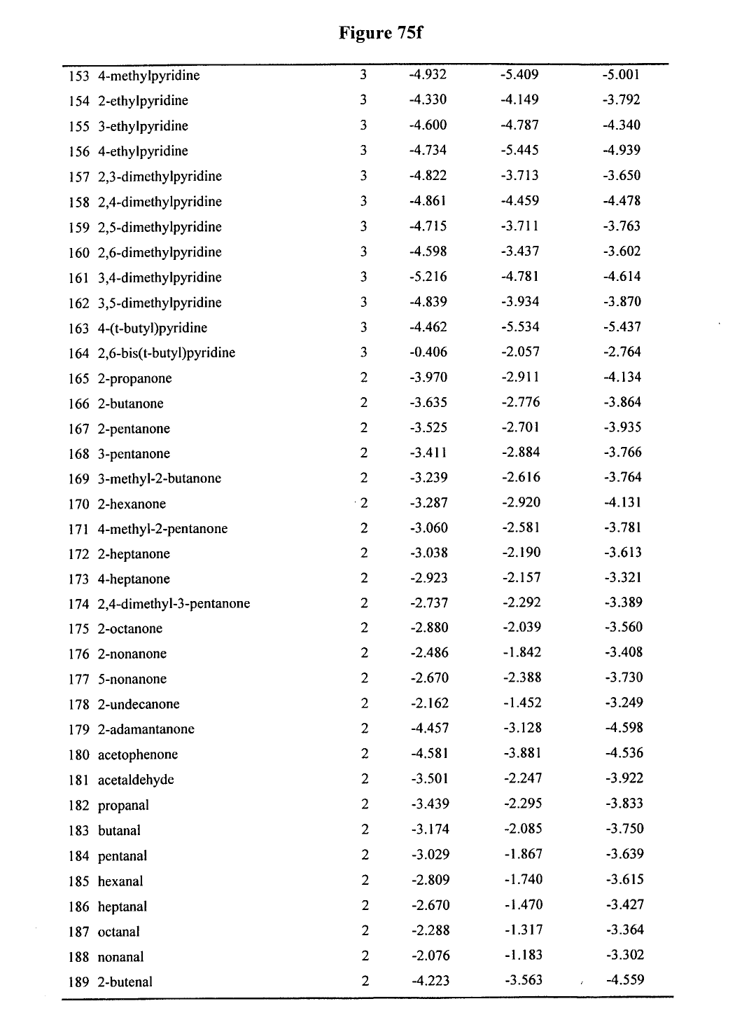

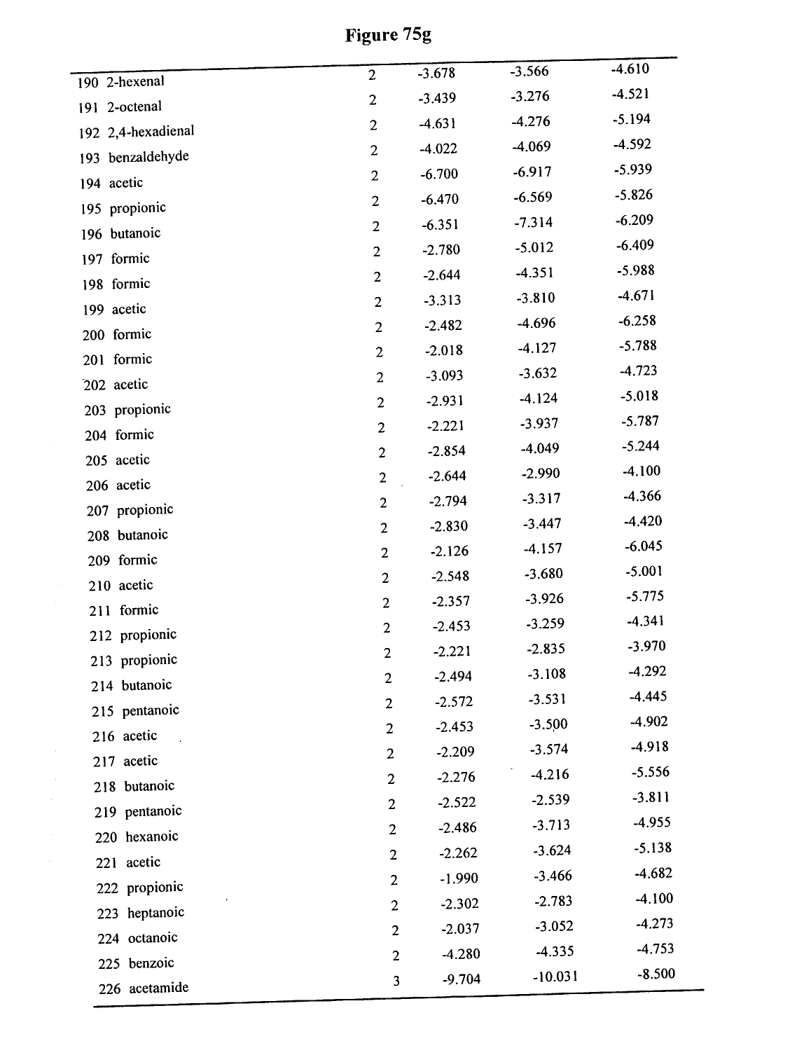

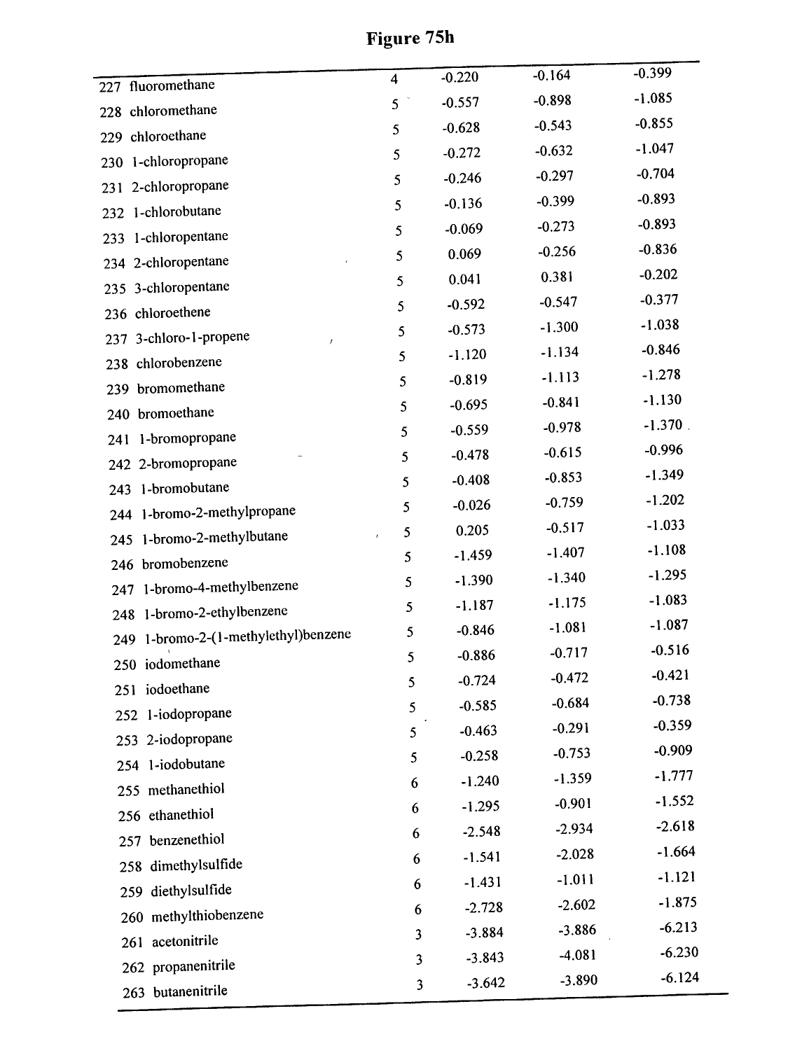

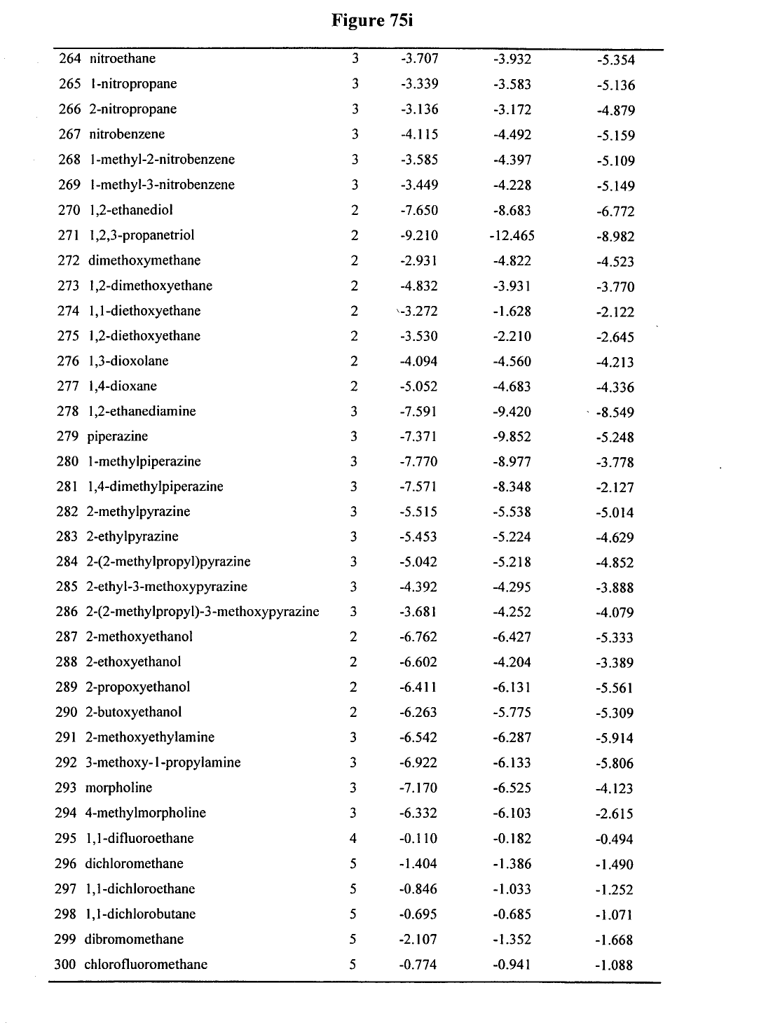

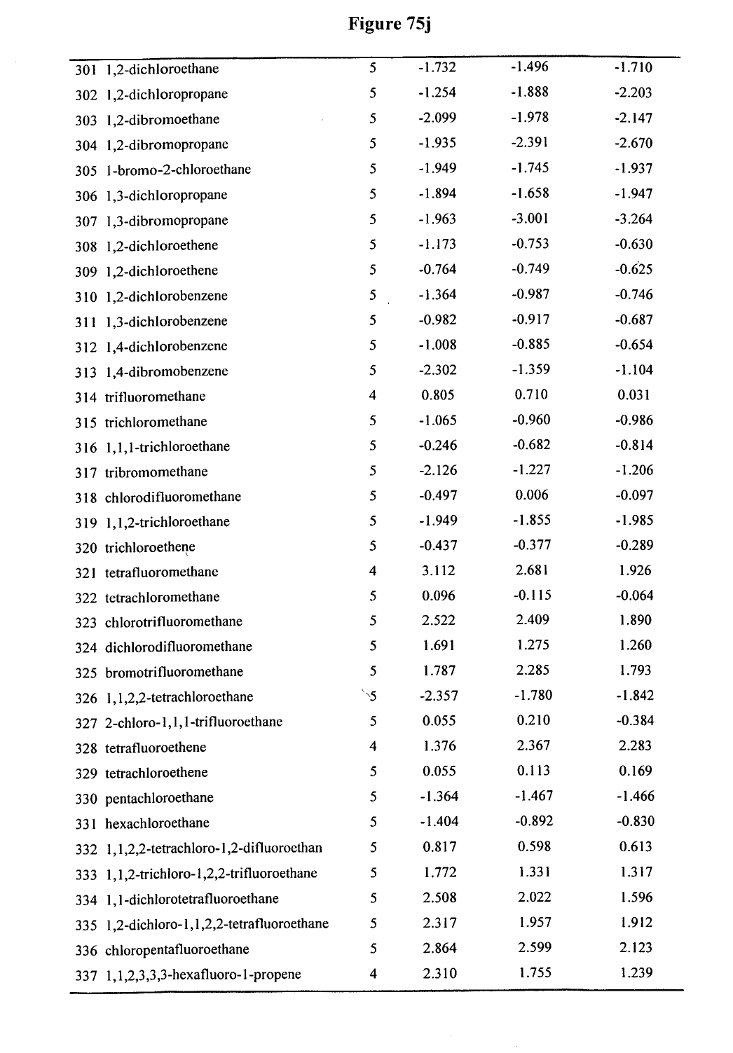

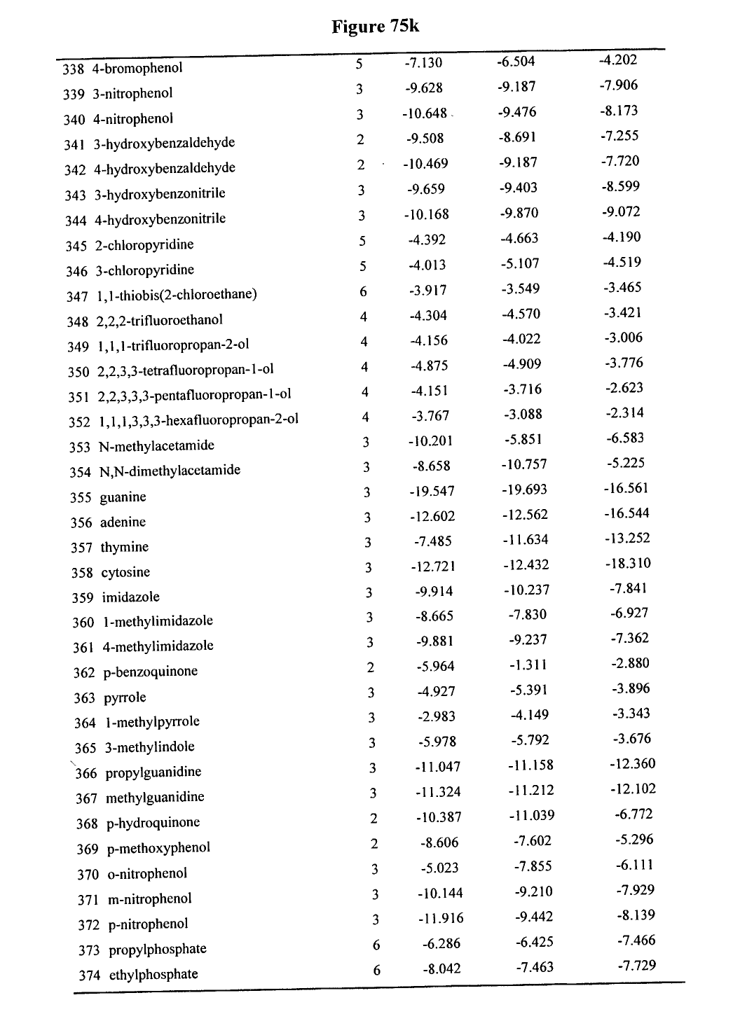

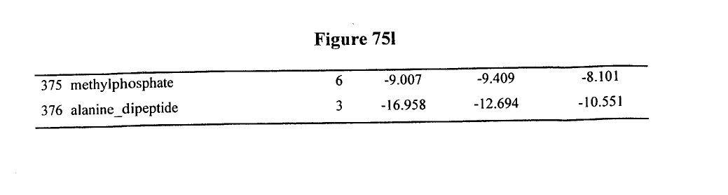

The comparison between the experimental and the predicted water solvation energies for the 376 small organic compounds is shown in FIG. 61. The name, experimental and predicted solvation energies are shown in Table 6 of FIG. 75.

The correlation between experimental and predicted values is quite good, R²=0.73. The mean unsigned error is 1.23 Kcal/Mol and the RMS deviation is 1.61 Kcal/Mol. The slope of the linear regression is 0.854. These results show that the use of equation (38) for the short-range term is a valid approximation because the predicted energies correlate quite well. However, the use of only element-dependent salvation types is probably an oversimplification. The local environment of each atom, as described by its hybridization and valence bond connectivity, certainly plays a role in the short-range solvation energy. Thus we will attempt to redo the short-range term parameterization for a more complicated set of solvation types.

The solvation types we used are from, Blanco M., California Institute of Technology, Private Communication, Unpublished Data (2001), and they are shown, along with the corresponding surface tensions in Table 3. The surface tensions were derived in a similar fashion as before. The starting point for the linear optimization procedure was the surface tensions per element that we already derived. Then, the linear optimization was done separately for each set of molecules belonging to the same chemical group. Each time we examined a new chemical group, all the previously determined surface tensions remained constant and only the new solvation types that are introduced by the new group were optimized.

TABLE 3
Solvation type definitions and surface tension values.

| Description | Solvation Type | Surface Tension |
|---|---|---|
| H bonded to sp3 C | H_MET | 0.005 |
| H bonded to sp2 C | H_BZN | −0.003 |
| H bonded to sp1 C | H_ACE | 0.038 |
| H bonded to sp3 C bonded to OH group | H_ALC | 0.041 |
| H bonded to sp3 N in primary amine | H_N31 | −0.019 |
| H bonded to sp2 N bonded to single C | H_N21 | 0.135 |
| H bonded to sp2 N in secondary amine | H_N32 | −0.150 |
| H bonded to sp2 N bonded to two C | H_N22 | 0.394 |
| H bonded to S | H_S | 0.055 |
| sp3 C in a diol | C_DOL | 0.085 |
| Any C bonded to sp1 N | C_N1 | 0.048 |
| Any C bonded to sp2 N | C_N2 | 0.002 |
| sp3 C bonded to sp3 N | C_N3 | 0.020 |
| Any other C | C_{—} | 0.010 |
| sp3 O bonded to two C | O_32 | −0.010 |
| Nitrous O | O_2N | 0.024 |
| Carbonyl O in peptide bond | O_PEP | −0.133 |
| Carboxylate O | O_2CM | 0.028 |
| Primary alcohol O or any other O | O_31 | −0.075 |
| sp3 N in tertiary amine | N_33 | −1.785 |
| sp2 N bonded to sp2 C and H | N_22 | −2.165 |
| Nitrous N | N_O2 | −0.246 |
| sp2 N in peptide bond | N_PEP | −0.084 |
| sp2 primary N bonded to sp2 C bonded to three sp2 N | N_NNH | 2.646 |
| Any other N | N_{—} | −0.035 |
| F bonded to sp3 C bonded to three F | F_MET | 0.019 |
| Any other F | F_{—} | 0.015 |
| Any Br | Br_{—} | −0.001 |
| Any Cl | Cl_{—} | 0.000 |
| Any I | I_{—} | −0.001 |
| Any P | P_{—} | 2.179 |
| Any S | S_{—} | −0.022 |

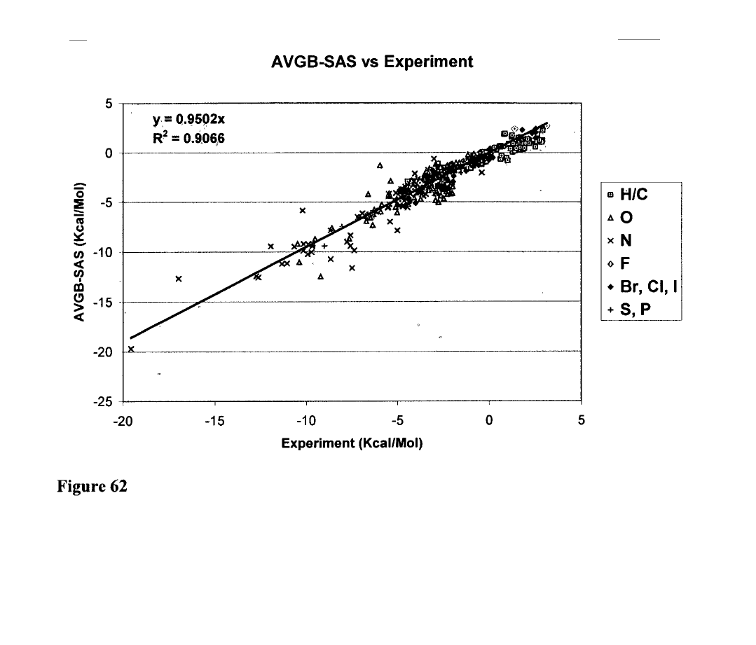

The comparison between the experimental and predicted solvation energies using the surface tensions of Table 3 is shown in FIG. 62. The average unsigned error is 0.72 Kcal/Mol and the RMS deviation 0.98 Kcal/Mol. The slope of the linear regression fit is 0.95 and the correlation coefficient is 0.9. Overall, the quality of the predictions of AVGB-SAS with the solvation types of Table 3 is very good. It is clear that the additional salvation types improve dramatically the predictions of the AVGB-SAS model. This fact could prompt us to continue refining our results by adding more salvation types. However, this would make the model more dependent on free parameters, which is not desired. At the same time, it is not clear by how much the derived surface tensions are applicable to molecules outside the set we used for optimization. We certainly expect that these results would be at least qualitatively right, but predicting the experimental values for all possible molecules is a rather futile goal. In any case, the method presented in this section can be used with any salvation type set.

The surface tensions we derived are strictly applicable for solvation in water. In order to use the AVGB-SAS model for other solvents one must repeat the optimization procedure presented here. The only limitation is the need for experimental solvation energy data for a sufficiently large and diverse molecule set, for the solvent of interest. After the atomic radii, the solvent probe radius and the atomic charges are determined, the polar energies can be calculated with AVGB with the respective interior/exterior dielectric constants for the new solvent. Then the procedure for calculating the surface tensions is identical to the one we used for water. The quality of the predictions, as compared to the experimental data, will determine if new solvation types will need to be defined.

### 4.0 Further Applications and Implmentations of the Methods According to the Invention

The AVGB-SAS salvation model was implemented and ported into two different molecular simulation packages, MPSim, Lim K. T., Brunett S., Iotov M., McClurg R. B., Vaidehi N., Dasgupta S., Taylor S., Goddard III W. A., J. Comp. Chem., 18, 501 (1997) and Dock, Ewing T. A., Makino S., Skillman A. G., Kuntz, I. D., J. Comp. Aid. Mol. Des., 15,411 (2001). MPSim is a parallel molecular dynamics program that uses the POSIX-threads multiprocessing standard, Hichols B., Buttlar D., Farrell J. P., Pthreads Programming, O'Reilly & Associates (1996) for parallelization. It is capable of performing molecular dynamics and energy minimization for very large systems under various thermodynamic ensembles. It can do cartesian, torsional or rigid-body dynamics and uses the cell-multipole method for fast calculation of the non-bond contributions to the atomic energies and forces, Ding H. Q., Karasawa N., Goddard III W. A., J. Chem Phys., 97, 4309 (1992). Dock is a molecular database searching program that ranks ligands by their ability to bind in a specified site of a receptor. For every ligand, it generates a number of conformations into the target site of the receptor that are scored and ranked by their binding energy. The purpose of Dock is to identify the ligands that bind best to a specific receptor as part of rational drug design. The reason for developing the AVGB-SAS model was to be able to incorporate salvation effects in an accurate and efficient way in such methods. The accuracy of the AVGB-SAS model was established in Sections 3-3.3. Here we will examine the performance of the model in these methods.

4.1 Parallel Molecular Dynamics

The AVGB-SAS model was implemented in MPSim, Lim K. T., Brunett S., Iotov M., McClurg R. B., Vaidehi N., Dasgupta S., Taylor S., Goddard III W. A., J. Comp. Chem, 18, 501 (1997). The solvation energy and the solvation force were added into the total energy and force of every atom. MPSim is ported in three different platforms/Operating Systems: SGI/Irix, IBM/AIX, Intel/Linux. The AVGB-SAS method was implemented in all three platforms and the timings for a 3401 atom protein (PDB code: 1 mcp) for each platform are shown in Figure. The tests were performed on an SGI Origin R10000 195 MHz, IBM Power3-II 375 MHz and Intel Pentium III 866 MHz respectively.

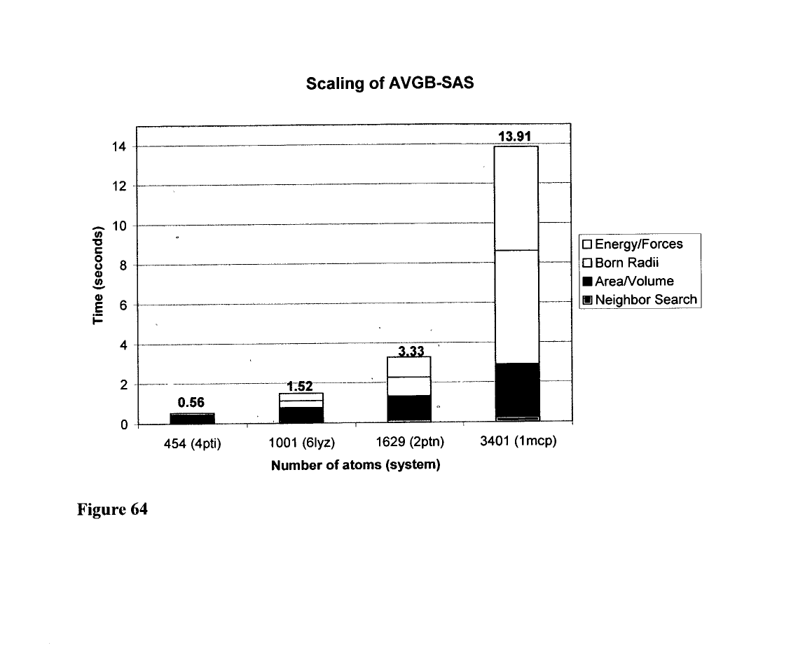

Each energy/force calculation includes the following steps: neighbor search for each atom, identification of the true neighbors and the area and volume calculation, Born radii calculation using equations (6) and (10) and polar solvation energy from equation (4). The short-range term is easily calculated after the areas for each atom have been determined. It is clear that the bulk of the CPU time spent for the calculation is on the Born radii and secondarily on the polar salvation energy/force calculation. This is because of the O(N²) nature of these calculations where N is the number of atoms in the molecular system. The area and volume calculations scale as O(N), as was shown in section 3.1.1 The overall scaling of the AVGB-SAS method is shown in FIG. 64.

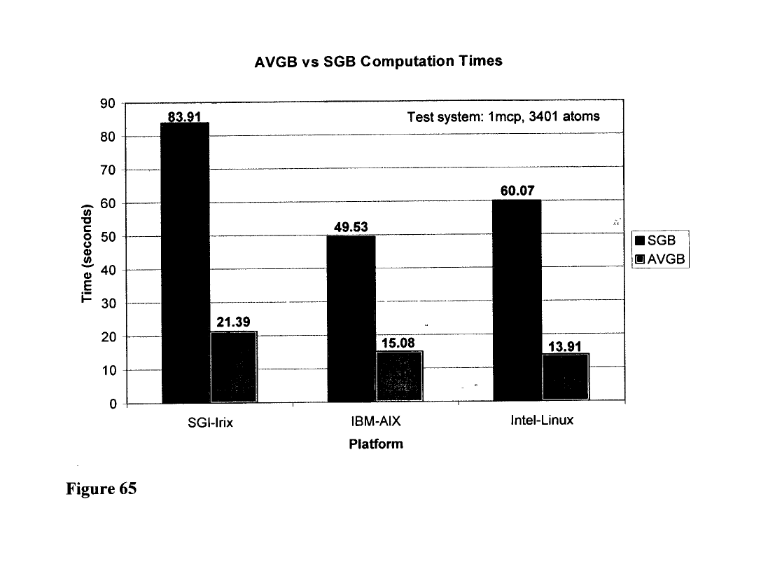

The CPU time required for the solvation energy calculation of the same test system, using numerical solutions to the PB equation, depends on the software and the grid resolution used. In any case, the minimum time spent was about a minute for Delphi and about 8 minutes for UHBD which is obviously very inefficient for use in molecular dynamics where a typical run involves at least calculations for a 1000 steps. The CPU time comparison of AVGB to SGB is shown in FIG. 65. AVGB is 3-5 times faster than SGB, depending on the platform. This is a significant improvement over other versions of the Generalized Born method.

We can boost the performance of AVGB-SAS even more by using parallel computers. The AVGB-SAS model is straightforwardly parallelizable due to the nature of the calculation. All the atoms in the system are uniformly distributed to all available processors. The solvent accessible surface and solvent excluded volume is calculated for every atom, independently of all other atoms. After the area and volume calculations are done, the Born radii and polar solvation energies can again be calculated independently for each atom using equations (10) and (4). The fact that the area, volume, Born radii and polar solvation energy for each atom are calculated independently of all other atoms means that the information necessary to be passed between different processors is minimal and this makes the algorithm naturally parallel.

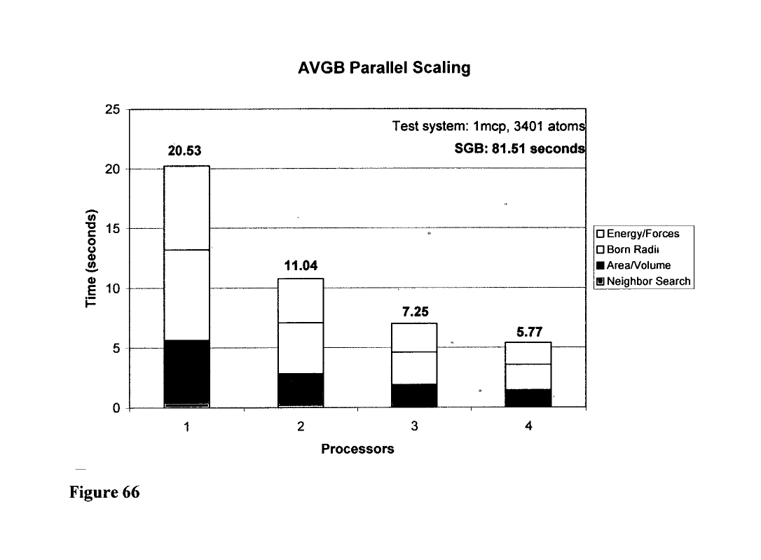

The scaling of the CPU time spent as a function of the number of processors used is shown in FIG. 66. This test was performed on a 4-processor SMP (Symmetric Multi Processor) shared memory machine, for the protein 1mcp (3401 atoms). The scaling is very good which means that the overhead due to processor communication is indeed minimal and the parallel implementation is very efficient. For 4 processors we get a boost of about 3.6 (or 360%) in the computation time. The time spent for the calculation of the same system using SGB (which is not parallelizable due to the global area calculation of the surface of the solute) is about 4 times more than AVGB for one processor and 14 for 4 processors. The excellent parallel performance of AVGB and the simplicity of the parallel implementation open the way for the simulation, including solvation effects, of very large systems with the use of massively parallel computers. In contrast, this is very difficult to do for methods that calculate numerically solutions of the PB equation.

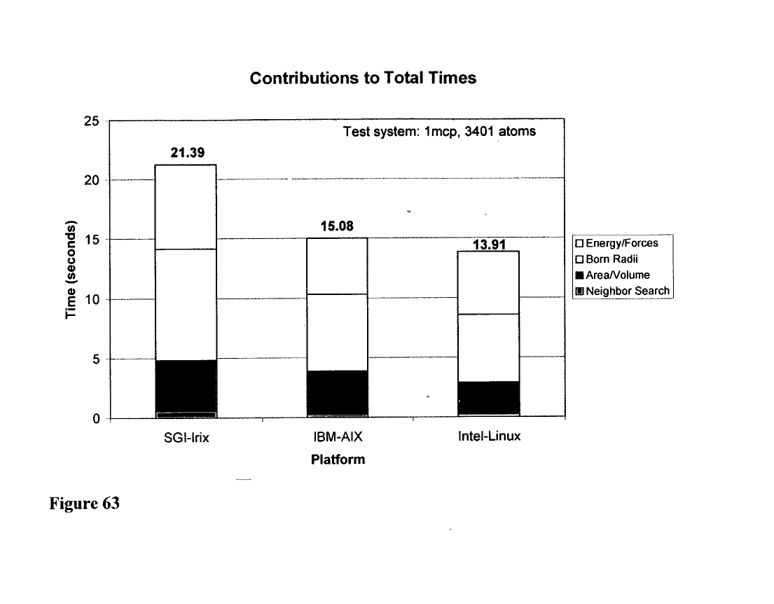

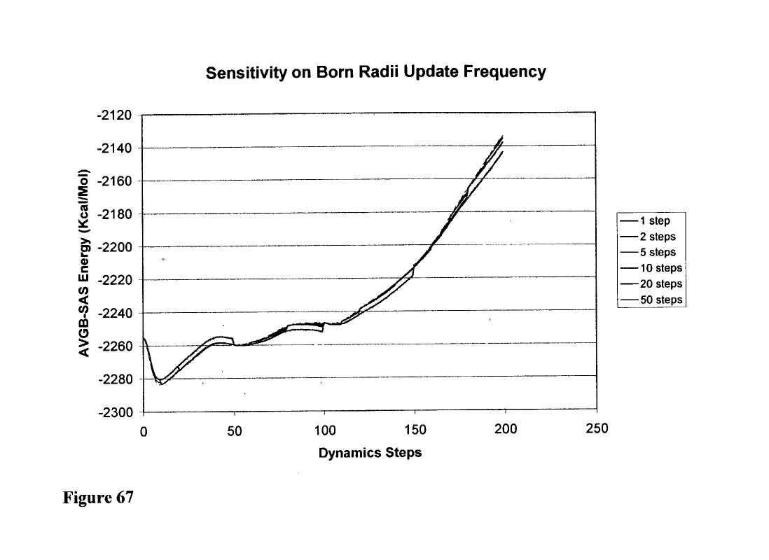

From the breakdown of the total CPU time to the individual contributions of the different parts of the AVGB-SAS calculation, FIG. 63, it is clear that the most expensive part of the calculation is the computation of the Born radii. In molecular dynamics, the calculation is done in successive steps that usually correspond to a time of 1 fs. After every step, the structure of the molecules changes very little. Only after a rather large number of steps (usually of the order of 100 or more) does the structure change noticeably. The exposed areas, volumes, Born radii and thus the polar solvation energy and short-range term are dependent exclusively on the structure of the solute. We expect then that the Born radii will not change by any significant amount in a few steps and accordingly the solvation energy. It is probably a good approximation to update the Born radii only every few steps, thus saving a lot of computation time. To test this we run dynamics for a small protein for 200 steps with different Born radii update frequencies: 1, 2, 5, 10, 20 and 50 steps. The solvation energy for each run is shown in FIG. 67.

We notice that the differences in the solvation energy are very small, just a few Kcal/Mol, and the trajectory of the dynamics is stable during the course of the run, even when updating the Born radii every 50 steps. By periodically updating the Born radii we gain significant increase in speed in the molecular dynamics, which are necessary for long time simulations.

4.2 Molecular Docking

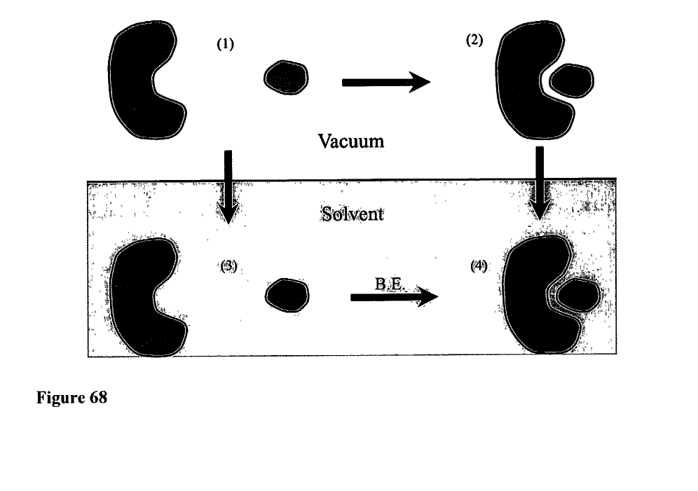

In molecular docking the goal is to rank a large number of ligands by their ability to bind in a specified site of a receptor as part of rational drug design. The particular conformations of each ligand in the binding site are scored according to the binding energy. It is important to include solvation effects in such calculations so that the selected ligands optimally bind with the receptor in the natural aqueous environment. The binding energy in solvent is calculated by using the thermodynamic cycle of FIG. 68.

Let us set as U^{L}, U^{R}, U^{C} the internal energy and ΔG^{L}, ΔG^{R}, ΔG^{C} the salvation energy of the ligand, receptor and ligand-receptor complex respectively. State 1 in FIG. 68 corresponds to the ligand and receptor in vacuum, separated by an infinite distance. State 2 is the complex in vacuum. State 3 is the ligand and receptor in solvent, separated by an infinite distance, and state 4 is the complex in the solvent. The energy required to get from state 1 to state 2 is

ΔW_{1→2}=U^{C}−U^{L}−U^{R} (8)

The energy required to get from 2 to 4 is the solvation energy of the complex, ΔW_{2→4}=ΔG^{C}, and the energy required to get from 1 to 3 is the sum of the individual solvation energies of the ligand and the receptor, ΔW_{1→3}=ΔG^{L}+ΔG^{R}. The binding energy of the ligand-receptor complex in water, B. E., may then be expressed as

$$\begin{matrix}B . E . = Δ {W}_{3 ⟶ 4} \\ = Δ {W}_{1 ⟶ 2} + Δ {W}_{2 ⟶ 4} - Δ {W}_{1 ⟶ 3} \\ = ( {U}^{C} + Δ {G}^{C} ) - ( {U}^{L} + Δ {G}^{L} ) - ( {U}^{R} + Δ {G}^{R} )\end{matrix} \qquad ( 9 )$$

So, for every ligand conformation generated, to calculate the binding energy we calculate the salvation energy of the ligand, the receptor and the complex, along with the internal energies of each system.

In order to save CPU time for the calculation, it is very common in docking simulations to assume the receptor to be fixed in space and only the ligand to be flexible as we search around the receptor's binding site to find an optimal configuration. This is a reasonable approximation because of the difference in the sizes of the two systems. A typical receptor has at least a few thousand atoms, where a ligand has not more than a hundred or so. This way, only the energy of the ligand and the interaction energy between ligand and receptor needs to be calculated. The intramolecular interactions in the receptor can be neglected since they are a constant for all possible ligand conformations.

We can use this fact to save additional CPU time in the calculation of the salvation energies. In particular, for most of the fixed atoms in the complex we need not calculate the areas and volumes since their intersecting neighbors are also fixed and thus the area and volume that they bury do not change. The fixed (receptor) atoms that need to be recalculated are the neighboring atoms of the movable (ligand) atoms. Also, an additional time saving approximation that can be done is at the Born radius calculation: the Born radius of an atom i is dependent on the volumes of all other atoms in the system. The contribution of each atom to the Born radius of atom i falls approximately as the inverse of the distance between the two atoms. Thus, for atoms that are fixed and far away from the binding site (where the ligand is) the Born radius should not change by much because of the presence of the ligand. For these atoms we use the initial Born radius value, without the ligand's contribution (receptor only). The Born radii are updated only for receptor atoms close to the ligand. With these additional schemes, we are able to reduce the solvation binding energy of a 4000-atom complex from 14s down to 2.5s, which is a significant improvement.

4.3 Further Applications

In Section 3.2-3.4 we examined the performance of the AVGB-SAS model as far as the quality of its predictions and the CPU time efficiency. The AVGB model has many advantages with respect to all previous methods for calculating the electrostatic solvation effects. In particular, the quality of the results is as good as for numerical solutions of the PB equation, but AVGB is orders of magnitude faster than various implementations of the PB model. At the same time the method is capable of calculating forces, analytically, which is necessary for the model to be useful in molecular dynamics. Unlike other variations of the Generalized Born theory, AVGB does not depend on any fitting parameters. Comparing AVGB to SGB, the only other GB method that does not depend on any ad-hoc parameterizations, AVGB is four times faster and the results are better. Also, the way the area and volume calculations are done allow for distributed computation of the solvation effects and as is shown in FIG. 66 the overhead of the parallel calculation is minimal, thus achieving good scaling and excellent CPU time performance. Finally, in the process of calculating the polar effects we have to calculate the solvent accessible areas for each atom, which is needed for the inclusion of short-range effects in the solvation energy. In the AVGB-SAS model, unlike other salvation methods, the long-range and short-range terms of the solvation energy and their derivatives are analytically calculated at the same time, which results in the excellent performance of the AVGB-SAS model.

We further implemented and incorporated the AVGB-SAS solvation model in MPSim, a parallel molecular dynamics program, and Dock, Ewing T. A., Makina S., Skillman A. G., Kuntz I. D., J. Comp. Aid. Mol. Des., 15, 411 (2001), a ligand database searching program. In Section 4.3.2 we will apply the AVGB-SAS model in the simulation of the dynamics of nucleic acids and in virtual ligand screening (VLS).

4.3.1 B-DNA Molecular Dynamics

Nucleic acids play a fundamental role in biological functions, and their accurate simulation is of primary importance. Because of DNA's importance and complexity, there is a strong focus in the scientific community to simulate accurately its dynamics (see: Cheatham III T. E., Kollman P A., Annu. Rev. Phys. Chem., 51, 435 (2000) for a review of molecular dynamics simulations of nucleic acids). The natural environment of DNA is water and DNA in solution exhibits complex dynamical behavior such as bending and stretching.

DNA has traditionally been a difficult system to simulate. It is a highly charged molecular system and long-range interactions have to be calculated accurately in order to maintain a stable double-helix structure. Also, it is essential that we include the effects of the water solvent in the simulation if we want to accurately simulate the behavior of DNA in its natural environment. Usually the water effects were incorporated by explicitly including water molecules in the simulation, with great expense in CPU time. In this section we show that by including solvation effects using the AVGB-SAS model, in a molecular dynamics simulation of DNA, we are able to achieve a stable double-helix structure and observe some dynamical effects.

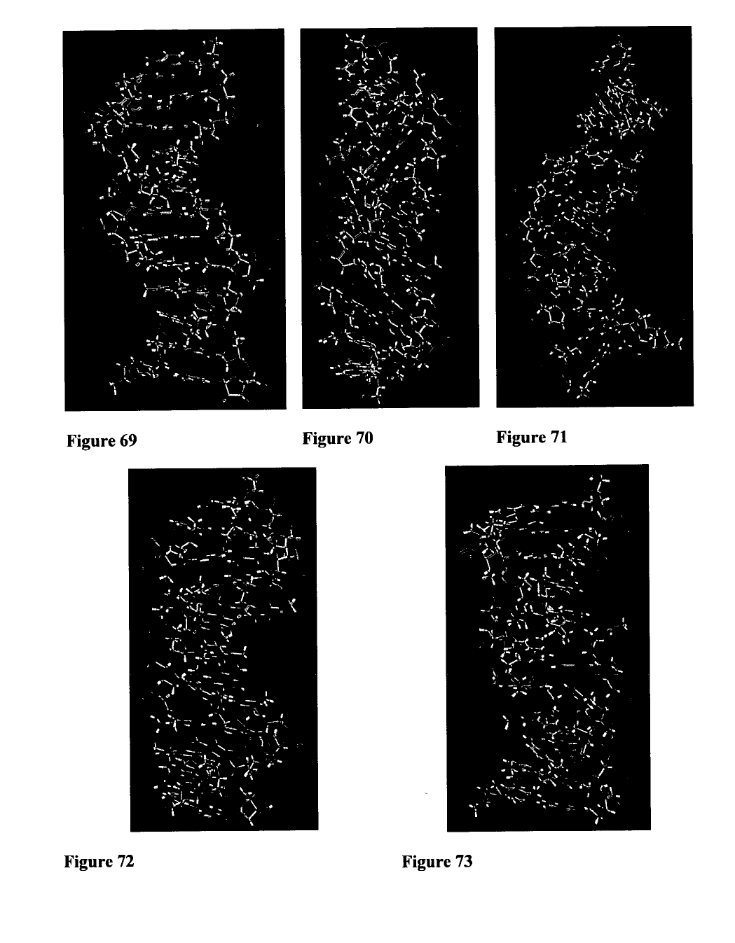

For the simulations we started from the canonical form of B-DNA, Arnott S., Hukins D. W. L., Biochem. Biophys. Res. Communs., 47, 1504 (1972) (FIG. 69) of the dodecamer d(CGCATATATGCG)₂ and used the molecular dynamics software package MPSim, Lim, K. T., Brunett S., Iotov M., McClurg R. B., Vaidehi N., Dasgupta S., Taylor S., Goddard III W. A., J. Comp. Chem, 18, 501 (1997) with the AMBER forcefield, Cornell W. D., Cieplak P., Bayly C. I., Gould I. R., Merz K. M., Ferguson D. M., Spellmeyer D. C., Fox T., Caldwell J. W., Kollman P. A., J. Am. Chem. Soc., 117, 5179 (1995). We performed 80 ps of dynamics in vacuum and in solvent, using AVGB-SAS for the calculation of energies and forces from the solvent to the DNA. We run the simulation with two different boundary conditions: free tips and fixed tips. The latter was done so we could prevent the double helix from bending, and allow us to compare the final structures to the canonical B-DNA structure.

The final structures for the unconstraint simulations are shown in FIG. 70 in vacuum and FIG. 71 in solvent. We note that when solvent is included, the double helix is bended, which is a phenomenon that has been observed experimentally, Ulyanov H. B., James T. L., Methods Enzymol., 261, 90 (1995). In contrast, the vacuum simulation does not clearly show such effect.

In the simulations where the tips of the double helices are fixed, the final structures are shown in FIG. 72 in vacuum and FIG. 73 in solvent. Because of this constraint we expect that a good quality simulation should preserve the structure of the double helix as close as possible to the canonical B-DNA form. Qualitatively we can verify that the solvent simulation preserves the structure, whereas the vacuum one does not do as well. We can quantify this by examining the root mean square deviation (RMSD) of the non-hydrogen atoms at each step in the simulation versus the canonical B-DNA.

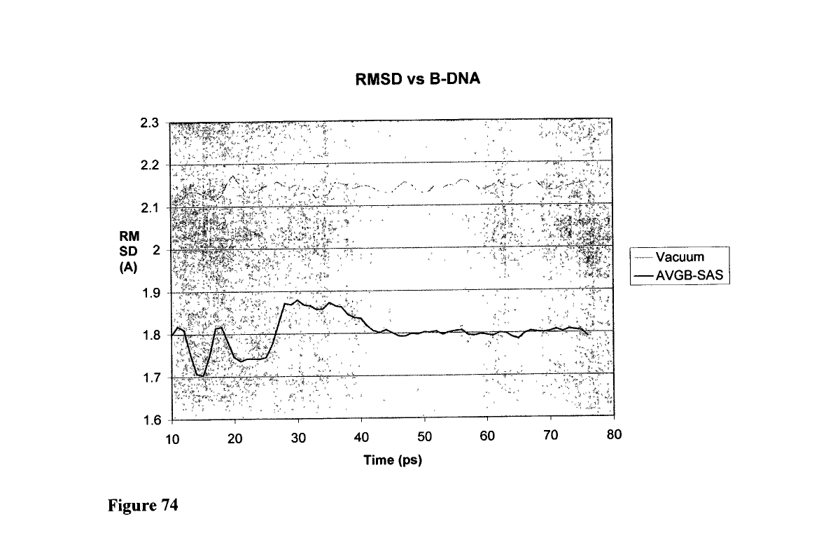

The plots in FIG. 74 show the RMSD of non-hydrogen atoms for every snapshot of the simulation (taken every 1 ps) versus the canonical B-DNA. The plots are 3-point averaged. We clearly see that the simulation in solvent produces structures that are closer to the canonical B-DNA than the vacuum simulation. This is a good indication that the solvent is indeed crucial in order to get a stable DNA structure and that the AVGB-SAS is a good method to simulate the solvent effects.

4.3.2 Virtual Ligand Screening (VLS)

Simulations can play a vital role in rational drug design. The recent discovery of the human genome, Venter J. C. et al., Science, 291, 1304 (2001) has made possible the identification of the sequence of proteins that mediate important cell functions. Drugs are small molecules (ligands) that bind to a specific site of a target protein (receptor) such that it will either stop or aid a function of that protein. Molecular simulations can assist in the discovery of such drugs by searching through large databases of potential ligands and identifying the best candidates according to their binding properties. This way, experiments can be done on a much smaller set of ligands in order to identify the right compound, saving significant time and resources in drug discovery.

If a protein's crystal structure is not known, we can use homology modeling, Baker D., Sali A., Science, 294, 93 (2001) and structure refinement techniques to predict the structure of the target protein. The target binding site is determined either by experimentally identified co-crystal structures or by computational techniques that examine the surface of the fused-sphere model of the protein, Liang J., Edelsbrunner H., Fu P., Sudhakar S. V., Subramaniam S., Proteins, 33, 1 (1998). For each ligand examined, a large number of conformations are generated and the binding energy of the ligand-receptor complex is calculated in order to rank the ligands.

In this example, we examine 11 proteins and a set of 37 co-crystals, listed in Table 4, and a screening library consisting of 10037 ligands against each protein. These structures were used in a comparative study of several algorithms for flexible ligand docking, Bursulaya B. D., Totrov M., Abagyan R., Brooks III C. L., J. Med. Chem., (submitted) which allow us to directly compare our results to other methods.

TABLE 4
List of proteins and co-crystal complexes examined.

| Target protein (nickname) | Complex PDB names |
|---|---|
| Intestinal FABP (fab) | 1icm |
| | 1icn |
| | 2ifb |
| Neuraminidase (nad) | 1nsc |
| | 1nsd |
| | 1nnb |
| Penicillopepsin (pep) | 1apt |
| | 1apu |
| ε-Thrombin (ret) | 1etr |
| | 1ets |
| | 1ett |
| Ribonuclease T₁ (rib) | 1gsp |
| | 1rhl |
| | 1rls |
| L-Arabinose binding protein (ara) | 1abe |
| | 1abf |
| | 5abp |
| Carbonic Anhydrase II (cah) | 1cil |
| | 1okl |
| | 1cnx |
| Carboxypeptidase A (car) | 1cbx |
| | 3cpa |
| | 6cpa |
| Cytochrome P-450_{cam} (cyt) | 1phf |
| | 1phg |
| | 2cpp |
| Thermolysin (tmn) | 3tmn |
| | 5tln |
| | 6tmn |
| Trypsin (trp) | 3ptb |
| | 1tng |
| | 1tni |
| | 1tnj |
| | 1tnk |
| | 1tnl |
| | 1tpp |
| | 1pph |

Since the best binders for each protein are already known (the 37 co-crystals) the goal in this test is to search the 10037 ligand database and identify the co-crystal ligands for each protein, as shown in Table 4, as the best binders. Because of the complexity of the problem we will consider as “successful” binders the top 2% of the ligands, as they are ranked according to their binding energy with each protein. Then, the success of the method will depend on how many of the co-crystal ligands show on the top 2% of the ranked 10037 ligand database.

We expect that the water solvent effects are very important for the right ranking of the ligands and it is important that we can include these effects accurately in the calculations. In order to assess the quality of the AVGB-SAS results in virtual ligand screening applications, we will perform the database search with and without solvation and then compare the number of the co-crystal ligands that are in the top 2% for every protein with each method. The database searching protocol we used utilizes both Dock, Eqing T. A., Makino S., Skillman A. G., Kuntz I. D., J. Comp. Aid. Mol. Des., 15,411 (2001) and MPSim, Lim K. T., Brunett S., Iotov M., McClurg R. B., Vaidehi N., Dasgupta S., Taylor S., Goddard III W. A., J. Comp. Chem. 18, 501 (1997) and it consists of the following steps:

Defining the docking region.

The docking regions for each target protein was defined based on the superposition of the co-crystal structures available for that target.

Protein grid calculation. Dock uses an energy grid for the protein contribution to the interaction energy. This grid is calculated once per target.

Level 0.

Docked conformations for each ligand were generated using flexible docking and energy scoring with minimization in Dock. The best 50 conformations for each ligand were saved and used in the subsequent steps.

Filter.

A combined criterion of exposed surface area and binding energy score from Dock is applied to each of the 50 conformations per ligand from level 0. The best 5 conformations are carried to the next step.

Level 1.

Minimization in vacuum for 25 steps with fixed protein coordinates using MPSim and the Dreiding forcefield, Mayo S. L. Olafson B. D., Goddard III W. A., J. Phys. Chem, 94, 8897 (1990) is performed for each of the 5 conformations per ligand that passed the filter. The best conformation per ligand is carried to the next step.

Ranking.

The protein-ligand affinities are calculated based on the energy of the best conformation from level 1, corrected by the energy of the free ligand in the initial (undocked) conformation. The ligand list is then sorted by binding affinities and the ranking of the corresponding co-crystal ligands is recorded. This step is done twice, once with solvation using AVGB-SAS and once in vacuum. The binding energy when solvation is included is given by equation (9).

The results from the protocol, for the solvation and vacuum screening of the 10037 ligands, along with the predictions from Dock, Ewing T. A., Makino S., Skillman A. G., Kuntz I. D., J. Comp. Aid. Mol. Des., 15, 411 (2001), FlexX, Rarey M., Kramer B., Lengauer T., Klebe G., J. Mol. Biol., 261, 470 (1996) and ICM, Totrov M., Abagyan R., Proteins, Suppl. 1, 215 (1997), as reported in, Bursulaya B. D., Totrov M., Abagyan, R., Brooks III C. L., J. Med. Chem., (submitted) are shown in Table 5.

Table 5. Comparison of VLS results from searching the 10037 ligand database of Bursulaya B. D., Totrov M., Abagyan, R., Brooks III C. L., J. Med. Chem., (submitted), using the protocol described, with and without solvation, along with the results from Dock, FlexX and ICM. The shaded entries identify the co-crystal ligands that rank in the top 2%.

| Co-crystal | Vacuum | Solvent | DOCK | FlexX | ICM |
|---|---|---|---|---|---|
| Fab | | | | | |
| 1icm | 2.85 | 1.67 | 10.1 | 68.8 | 2.6 |
| 1icn | 5.21 | 1.16 | 3.4 | 74.4 | 0.5 |
| 2ifb | 1.21 | 0.12 | 7.1 | 99.3 | 0.5 |
| Nad | | | | | |
| 1nnb | 0.26 | 0.02 | 6.7 | 1.4 | 0.43 |
| 1nsc | 0.29 | 0.05 | 19 | 7.2 | 5.01 |
| 1nsd | 0.16 | 0.13 | 9.4 | 3 | 0.44 |
| Pep | | | | | |
| 1apt | 0.12 | 0.07 | 0.3 | 41 | 1.1 |
| 1apu | 34.74 | 1.53 | 3.8 | 80 | 12.8 |
| Ret | | | | | |
| 1etr | 4.93 | 0.28 | 5.6 | 0.5 | 1.6 |
| 1ets | 1.29 | 0.03 | 0.4 | 0.3 | 6.7 |
| 1ett | 13.35 | 3.02 | 0.9 | 9 | 0.06 |
| Rib | | | | | |
| 1gsp | 0.62 | 0.25 | 4.4 | 10.7 | 0.6 |
| 1rhl | 0.64 | 0.66 | 5.6 | 10.2 | 0.4 |
| 1rls | 0.56 | 0.19 | 68.9 | 7.4 | 12.3 |
| Ara | | | | | |
| 1abe | 6.88 | 0.75 | 0.5 | 0.2 | 0.01 |
| 1abf | 6.15 | 0.15 | 1.2 | 0.2 | 0.03 |
| 5abp | 6.85 | 0.23 | 0.2 | 0.4 | 0.02 |
| Cah | | | | | |
| 1cil | 50.30 | 18.53 | 35 | 3.7 | 71.7 |
| 1okl | 72.31 | 30.52 | 18.5 | 19.3 | 30.9 |
| 1cnx | 87.85 | 33.92 | 0.3 | 14.5 | 90.6 |
| Car | | | | | |
| 1cbx | 0.18 | 0.10 | 36.8 | 2.7 | 0.2 |
| 3cpa | 22.13 | 6.23 | 14.2 | 1.4 | 0.3 |
| 6cpa | 0.04 | 0.03 | 8.5 | 2.7 | 3.4 |
| 1phf | 14.44 | 7.39 | 26.9 | 13.2 | 3.7 |
| 1phg | 29.72 | 21.51 | 60.6 | 1.4 | 12.7 |
| 2cpp | 13.99 | 7.11 | 7.3 | 12.6 | 11.7 |
| Tmn | | | | | |
| 3tmn | 76.95 | 5.59 | 34.3 | 3.5 | 2.8 |
| 5tln | 36.62 | 49.58 | 66 | 0.6 | 28.5 |
| 6tmn | 60.81 | 48.49 | 15 | 8.5 | 77.6 |
| Trp | | | | | |
| 3ptb | 7.21 | 3.42 | 20.3 | 14 | 0.1 |
| 1tng | 20.83 | 31.00 | 28.7 | 30.8 | 0.3 |
| 1tni | 43.95 | 65.80 | 43.6 | 38.5 | 0.6 |
| 1tnj | 44.84 | 67.75 | 45.1 | 47.9 | 1.1 |
| 1tnk | 44.24 | 64.00 | 58.1 | 37.1 | 14.6 |
| 1tnl | 18.71 | 21.78 | 82.9 | 39.1 | 51.6 |
| 1tpp | 2.34 | 0.41 | 4 | 0.3 | 0.4 |
| 1pph | 1.27 | 0.10 | 37 | 0.6 | 0.3 |

The entries in Table 5 correspond to the percentage of ligands in the 10037-compound database that score better than the corresponding co-crystal ligand for the respective protein. Shaded entries identify the co-crystals for which the respective docking method ranked it in the top 2%. Such rankings are considered successful because the co-crystal ligand is by definition a top binder to its receptor. Clearly, a good VLS method should identify most of the co-crystal ligands in the top 2%, if not all of them. The protocol described above, without solvation, identifies only 12 out of the 37 co-crystal ligands as top binders. In contrast, when salvation is included, using AVGB-SAS, 20 of the co-crystal ligands are in the top 2%. The best other VLS methods in the literature, Dock, FlexX and ICM score 7, 11 and 20 co-crystal ligands in the top 2% respectively. These results clearly demonstrate the importance of the solvation effects in VLS and the success of the AVGB-SAS model for describing such effects.

5.0 Systems According to the Invention

Another aspect of the invention is a computer system which is programmed to perform the methods according to the invention. The methods according to the invention may be implemented in any desktop personal computer or network server with sufficient memory, and storage. A suitable computer system and hardware configuration is a Pentium based desktop computer or server, running Microsoft NT (or a Linux based operating system such as distributed by Red Hat, Inc. (Durham, N.C.)), with at least 128MB of random access memory, and 10GB storage. Such systems may be readily purchased from Dell, Inc. (Austin, Tex.), Hewlett-Packard, Inc., (Palo Alto, Calif.) or Compaq Computers, Inc., (Houston, Tex.). Optionally a computer system according to the invention may further comprise a Line-Area-Network card, such as 10/100 Ethernet card and the necessary software.

In general, a system according to the invention comprises a processing means, a memory means, an input means, an output means, an operating system means, and a programming means for the methods according to the invention. The systems according to the invention may also comprise a means for networking to another device.

A processing means may include one or more microprocessor(s), field programmable logic array(s), or one or more application specific integrated circuit(s). Exemplary processors include Intel Corp.'s Pentium series processor (Santa Clara, Calif.), Motorola Corp.'s PowerPC processors (Schaumberg, Ill.), MIPS Technologies Inc.'s MIPs processors (Mountain View, Calif.), or Xilinx Inc.'s Vertex series of field programmable logic arrays (San Jose, Calif.).

A memory means includes any electronic, magnetic or optical based media for storing digital information or a combination of such media. Exemplary types of memory include random access memory, electronically programmable read only memory, flash memory magnetic based disk and tape drives, and optical based disk drives. The memory means stores the programming for the methods according to the invention.

An input means may include a keyboard and mouse or a touch screen/tablet or some combination thereof.

An output means may include one or more visual displays and or printers. A visual display may be based upon any monitor technology known in the art including, cathode ray tube based monitors/projectors, plasma based monitors, liquid crystal display based monitors, digital micromirror device based projectors, or lightvalve based projectors.

An operating system means is programming for controlling the data flow between the processor means, memory means, input means, and the output means. Exemplary operating system means include Microsoft Corp's Windows and NT (Redmond, Washington), Sun Microsystem Inc.'s Solaris Operating System (Palo Alto, Calif.), Red Hat Corp.'s version of Linux (Durham, N.C.) and Palm Corp.'s PALM OS (Milpitas, Calif.).

Each and every reference cited above herein is hereby incorporated by reference as if fully set forth herein. Although the invention has been described with reference to preferred embodiments and specific examples, it will be readily appreciated by those skilled in the art that many modifications and adaptations of the invention are possible without deviating from the spirit and scope of the invention. Thus, it is to be clearly understood that this description is made only by way of example and not as a limitation on the scope of the invention as claimed below.

What is claimed is:

1. A method for determining the molecular volume of a solvated solute wherein said solute comprises a plurality of atoms comprising the steps of:
a. modeling said solute as a set of fused spheres;
b. decomposing said set of fused spheres into a plurality of discrete polyhedral sub-volumes wherein each sub-volume corresponds to an atom in the fused spheres;
c. selecting a particular polyhedral sub-volume from the plurality of polyhedral sub-volumes determined in step b thereby determining a selected polyhedral sub-volume
d. decomposing said selected polyhedral sub-volume into a plurality of cone-pyramids and a spherical sector;
e. determining the total volume of said plurality of cone-pyramids and said spherical sector produced by the decomposition of said selected polyhedral sub-volume by applying the Gauss-Bonnet theorem in combination with the coordinate system shown in FIG. 12;
f. repeating steps c-e for each polyhedral sub-volume produced in step b.
g. determining the volume of the set of fused spheres by summing the sub-volumes determined in step f.

2. A method for determining the molecular volume of a solvated solute wherein said solute comprises a plurality of atoms comprising the steps of:
a. modeling said solute as a set of fused spheres;
b. partitioning a simulation space into a regular array of cells;
c. assigning each atom of said solute to a cell;
d. selecting a particular atom of said solute thereby defining a central atom;
e. determining which atoms intersect said central atom;
f. determining which intersecting atoms to the central atom limit its exposed surface area;
g. determining the connectivity of said intersecting atoms determined in step f;
h. determining a plurality of Gauss-Bonnet paths on the surface of said central atom from said determination of the connectivity of said intersecting atoms determined in step f thereby defining a spherical sector;
i. determining a plurality of planar sections of said central atom defined by the intersection of said atoms determined in step f with said central atom thereby defining a plurality of cone-pyramids;
j. applying the Gauss-Bonnet theorem in combination with the coordinate system shown in FIG. 12 to determine the total volume of the spherical sector determined in step h and the volume of the cone-pyramids defined by the planar sections determined in step i;
k. repeating step d-j for each atom of said solute; and
l. determining the volume of the set of fused spheres by summing the sub-volumes determined in step k.

3. A method for determining the molecular surface are of a solvated solute wherein said solute comprises a plurality of atoms comprising the steps of:
a. modeling said solute as a set of fused spheres;
b. partitioning a simulation space into a regular array of cells;
c. assigning each atom of said solute to a cell in said array;
d. selecting one atom from said solute thereby defining a central atom;
e. determining which atoms intersect said central atom;
f. determining which intersecting atoms to the central atom limit its exposed surface area;
g. determining the connectivity of said intersecting atoms determined in step f;
h. determining a plurality of Gauss-Bonnet paths on the surface of said central atom from said determination of the connectivity of said intersecting atoms determined in step g, thereby defining a spherical sector;
i. applying the Gauss-Bonnet theorem in combination with the coordinate system shown in FIG. 12 to determine the buried surface area of said spherical sector;
j. determining the surface area of said spherical sector from said buried surface area determined in step i; and
k. repeating step d-j for each atom of said solute; and
l. determining the surface area of the set of fused spheres by summing the partial surface areas determined in step k.

4. A method for determining the Born radii using Equations (6) and (10) wherein the volume V_{k′} is calculated using the method of claim 1.

5. A method for determining the Born radii using Equations (6) and (10) wherein the volume V_{k′} is calculated using the method of claim 2.

6. A computer system comprising programming for the method of claim 1.

7. A computer system comprising programming for the method of claim 2.
